(19) United States
(12) Patent Application Publication
(10) Pub. No.: US 2009/0147995 A1
(43) Pub. Date: Jun. 11, 2009

(54) INFORMATION PROCESSING APPARATUS AND INFORMATION PROCESSING METHOD, AND COMPUTER PROGRAM

(76) Inventors: Tsutomu SAWADA, Tokyo (JP); Takeshi Ohashi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/329,165

(22) Filed: Dec. 5, 2008

(30) Foreign Application Priority Data
Dec. 7, 2007 (JP) P2007-317711

(51) Int. Cl. G06K 9/00; G10L 17/00

(52) U.S. Cl. 382/103; 704/246; 704/E17.003

(57) ABSTRACT

An information processing apparatus includes information input units which inputs observation information in a real space; an event detection unit which generates event information including estimated position and identification information on users existing in the actual space through analysis of the input information; and an information integration processing unit which sets hypothesis probability distribution data regarding user position and user identification information and generates analysis information including the user position information through hypothesis update and sorting out based on the event information, in which the event detection unit detects a face area from an image frame input from an image information input unit, extracts face attribute information from the face area, and calculates and outputs a face attribute score corresponding to the extracted face attribute information to the information integration processing unit, and the information integration processing unit applies the face attribute score to calculate target face attribute expectation values.

### CROSS REFERENCES TO RELATED APPLICATIONS

The present invention contains subject matter related to Japanese Patent Application JP 2007-317711 filed in the Japanese Patent Office on Dec. 7, 2007, the entire contents of which are incorporated herein by reference.

### BACKGROUND OF THE INVENTION

1. Field of the Invention

The present invention relates to an information processing apparatus and an information processing method, and a computer program. In particular, the invention relates to an information processing apparatus and an information processing method, and a computer program in which information from an external world, for example, an image, an audio, or the like is input, and an analysis on an external environment based on the input information, to be more specific, a processing of analyzing a position of a person emitting a word or who is the person emitting the word, and the like is executed.

2. Description of the Related Art

A system configured to perform a mutual processing between a person and an information processing apparatus such as a PC or a robot, for example, a system of performing a communication or an interactive processing is called a man-machine interaction system. In this man-machine interaction system, the information processing apparatus such as the PC or the robot inputs image information or audio information for recognizing an action of a person, for example, a motion or a word of the person, and performs an analysis based on the input information.

In a case where a person transmits information, the person utilizes not only the word, but also various channels such as a body language, a sight line, and an expression as an information transmission channel. If an analysis on a large number of such channels can be performed in the machine, the communication between the person and the machine can reach a similar level to the communication between persons. An interface for analyzing the input information from such a plurality of channels (also referred to as modalities or modals) is called a multi-modal interface. A research and development of the multi-modal interface has been actively conducted in recent years.

For example, in a case where image information captured by a camera and audio information obtained through a microphone are input and analyzed, in order to perform a more detailed analysis, it is effective to input a large number of information pieces from a plurality of cameras and a plurality of microphones installed at various points.

As a specific system, for example, the following system is conceivable. Such a system can be realized that an information processing apparatus (television) inputs an image and audio of users (father, mother, sister, and brother) existing in front of the television via cameras and microphones, and an analysis of positions of the respective users and who emits a certain word is performed, for example. Then, the television performs a processing in accordance with the analysis information, for example, zooming up of the camera to the user who performs a discourse, an appropriate response to the user who performs the discourse, and the like.

Many of general man-machine interaction systems in related art integrate information from a plurality of channels (modals) in a deterministic manner and perform a processing of deciding where the plurality of users are respectively located, who the users are, and by whom a certain signal is emitted. For example, as the related art technology, Japanese Unexamined Patent Application Publication No. 2005-271137 and Japanese Unexamined Patent Application Publication No. 2002-264051 disclose such systems.

However, according to the integration processing method performed in the related art system in the deterministic manner of utilizing uncertain and asynchronous data input from the microphones and cameras, robustness is lacking and there is a problem that only data with a low accuracy can be obtained. In the actual system, sensor information which can be obtained in a real environment, that is, input images from the cameras and audio information input from the microphones, is uncertain data including various pieces of insignificant information, for example, noise and inefficient information. In order to perform an image analysis processing and an audio analysis processing, it is important to perform a processing of efficiently integrating pieces of useful information from the above-mentioned sensor information.

### SUMMARY OF THE INVENTION

The present invention has been made in view of the above-described circumstances, and the invention therefore provides an information processing apparatus and an information processing method, and a computer program in an analysis on input information from a plurality of channels (modalities or modals), to be more specific, for example, in a system of performing a processing of identifying positions of persons in a surrounding area and the like, a probabilistic processing is performed on uncertain information included in various pieces of input information such as image information and audio information, and a processing of integrating information pieces estimated to have a high accuracy is performed, so that robustness is improved and an analysis with a high accuracy is performed.

According to an embodiment of the present invention, there is provided an information processing apparatus including: a plurality of information input units configured to input observation information in a real space; an event detection unit configured to generate event information including estimated position information and estimated identification information on users existing in the actual space through an analysis of the information input from the information input units; and an information integration processing unit configured to set hypothesis probability distribution data related to position information and identification information on the users and generate analysis information including the position information on the users existing in the real space through a hypothesis update and a sorting out based on the event information, in which the event detection unit is a configuration of detecting a face area from an image frame input from an image information input unit, extracting face attribute information from the detected face area, calculating a face attribute score corresponding to the extracted face attribute information, and outputting the face attribute score to the information integration processing unit, and the information integration processing unit applies the face attribute score input from the event detection unit and calculates face attribute expectation values corresponding to the respective targets.

Furthermore, in the information processing apparatus according to the embodiment of the present invention, the information integration processing unit is a configuration of executing a particle filter processing to which a plurality of particles are applied in which plural pieces of target data corresponding to virtual uses are set and generating the analysis information including the position information on the users existing in the real space, and the information integration processing unit has a configuration of setting the respective pieces of target data set to the particles while being associated with the respective events input from the event detection unit, and updating the event corresponding target data selected from the respective particles in accordance with an input event identifier.

Furthermore, in the information processing apparatus according to the embodiment of the present invention, the information integration processing unit has a configuration of performing the processing while associating the targets with the respective events in units of a face image detected in the event detection unit.

Furthermore, in the information processing apparatus according to the embodiment of the present invention, the information integration processing unit is a configuration of executing the particle filtering processing and generating the analysis information including the user position information and the user identification information on the users existing in the real space.

Furthermore, in the information processing apparatus according to the embodiment of the present invention, the face attribute score detected by the event detection unit is a score generated on the basis of a mouth motion in the face area, and the face attribute expectation value generated by the information integration processing unit is a value corresponding to a probability that the target is a speaker.

Furthermore, in the information processing apparatus according to the embodiment of the present invention, the event detection unit executes the detection of the mouth motion in the face area through a processing to which VSD (Visual Speech Detection) is applied.

Furthermore, in the information processing apparatus according to the embodiment of the present invention, the information integration processing unit uses a value of a prior knowledge [Sₚᵣᵢₒᵣ] set in advance in a case where the event information input from the event detection unit does not include the face attribute score.

Furthermore, in the information processing apparatus according to the embodiment of the present invention, the information integration processing unit is a configuration of applying a value of the face attribute score and a speech source probability P(tID) of the target calculated from the user position information and the user identification information during an audio input period which are obtained from the detection information of the event detection unit and calculating speaker probabilities of the respective targets.

Furthermore, in the information processing apparatus according to the embodiment of the present invention, when the audio input period is set as Δt, the information integration processing unit is a configuration of calculating speaker probabilities [Ps(tID)] of the respective targets through a weighting addition to which the speech source probability P[(tID)] and the face attribute score [S(tID)] are applied, by using the following expression:

Ps(tID)=Ws(tID)/ΣWs(tID)

wherein

Ws(tID)=(1−α)P(tID)Δt+αS_{Δt}(tID)
α is a weighting factor.

Furthermore, in the information processing apparatus according to the embodiment of the present invention, when the audio input period is set as Δt, the information integration processing unit is a configuration of calculating speaker probabilities [Pp(tID)] of the respective targets through a weighting multiplication to which the speech source probability P[(tID)] and the face attribute score [S(tID)] are applied, by using the following expression:

Pp(tID)=Wp(tID)/ΣWp(tID)

wherein

Wp(tID)=(P(tID)Δt)^{(1-α)}×S_{66 t}(tID)^{α}
α is a weighting factor.

Furthermore, in the information processing apparatus according to the embodiment of the present invention, the event detection unit is a configuration of generating the event information including estimated position information on the user which is composed of a Gauss distribution and user certainty factor information indicating a probability value of a user correspondence, and the information integration processing unit is a configuration of holding particles in which a plurality of targets having the user position information composed of a Gauss distribution corresponding to a virtual user and confidence factor information indicating the probability value of the user correspondence are set.

Furthermore, in the information processing apparatus according to the embodiment of the present invention, the information integration processing unit is a configuration of calculating a likelihood between event generation source hypothesis targets set in the respective particles and the event information input from the event detection unit and setting values in accordance with the magnitude of the likelihood in the respective particles as particle weights.

Furthermore, in the information processing apparatus according to the embodiment of the present invention, the information integration processing unit is a configuration of executing a resampling processing of reselecting the particle with the large particle weight in priority and performing an update processing on the particles.

Furthermore, in the information processing apparatus according to the embodiment of the present invention, the information integration processing unit is a configuration of executing an update processing on the targets set in the respective particles in consideration with an elapsed time.

Furthermore, in the information processing apparatus according to the embodiment of the present invention, the information integration processing unit is a configuration of generating signal information as a probability value of an event generation source in accordance with the number of event generation source hypothesis targets set in the respective particles.

In addition, according to an embodiment of the present invention, there is provided an information processing method of executing an information analysis processing in an information processing apparatus, the information processing method including the steps of: inputting observation information in a real space by a plurality of information input units; generating event information including estimated position information and estimated identification information on users existing in the actual space by an event detection unit through an analysis of the information input from the information input units; and setting hypothesis probability distribution data related to position information and identification information on the users and generating analysis information including the position information on the users existing in the real space by an information integration processing unit through a hypothesis update and a sorting out based on the event information, in which the event detection step includes detecting a face area from an image frame input from an image information input unit, extracting face attribute information from the detected face area, calculating a face attribute score corresponding to the extracted face attribute information, and outputting the face attribute score to the information integration processing unit, and the information integration processing step includes applying the face attribute score input from the event detection unit and calculating face attribute expectation values corresponding to the respective targets.

Furthermore, in the information processing method according to the embodiment of the present invention, the information integration processing step includes performing the processing while associating the targets with the respective events in units of a face image detected in the event detection unit.

Furthermore, in the information processing method according to the embodiment of the present invention, the face attribute score detected by the event detection unit is a score generated on the basis of a mouth motion in the face area, and the face attribute expectation value generated in the information integration processing step is a value corresponding to a probability that the target is a speaker.

In addition, according to an embodiment of the present invention, there is provided a computer program for executing an information analysis processing in an information processing apparatus, the computer program including the steps of: inputting observation information in a real space by a plurality of information input units; generating event information including estimated position information and estimated identification information on users existing in the actual space by an event detection unit through an analysis of the information input from the information input units; and setting hypothesis probability distribution data related to position information and identification information on the users and generating analysis information including the position information on the users existing in the real space by an information integration processing unit through a hypothesis update and a sorting out based on the event information, in which the event detection step includes detecting a face area from an image frame input from an image information input unit, extracting face attribute information from the detected face area, calculating a face attribute score corresponding to the extracted face attribute information, and outputting the face attribute score to the information integration processing unit, and the information integration processing step includes applying the face attribute score input from the event detection unit and calculating face attribute expectation values corresponding to the respective targets.

It should be noted that the computer program according to the embodiment of the present invention is a computer program which can be provided to a general use computer system capable of executing various program codes, for example, by way of a storage medium or a communication medium in a computer readable format. By providing such a program in a computer readable format, the processing in accordance with the program is realized on the computer system.

Further features and advantages of the present invention will become apparent from the following detailed description of and exemplary embodiments and the accompanying drawings of the present invention. It should be noted that the system described in the present specification is a logical collective structure of a plurality of apparatuses, and is not limited to an example in which the apparatuses of the respective configurations are accommodated in the same casing.

According to the embodiment of the present invention, the event information including the estimated position information and estimated identification information on the users is input on the basis of the image information and the audio information obtained from the cameras and the microphones is input, the face area is detected from the image frame input from the image information input unit, the face attribute information is extracted from the detected face area, and the face attribute score corresponding to the extracted face attribute information is extracted is applied to calculate the face attribute expectation values corresponding to the respective targets. Even when the uncertain and asynchronous position information and identification information are set as the input information, it is possible to efficiently allow the plausible information to remain, and the user position information and the user identification information can be efficiently generated with certainty. In addition, the highly accurate processing for identifying the speaker or the like is realized.

### BRIEF DESCRIPTION OF THE DRAWINGS

FIG. 1 is an explanatory diagram for describing an outline of a processing executed by an information processing apparatus according to an embodiment of the present invention;

FIG. 2 is an explanatory diagram for describing a configuration and a processing of the information processing apparatus according to an embodiment of the present invention;

FIGS. 3A and 3B are explanatory diagrams for describing an example of information generated by an audio event detection unit and an example of information generated by an image event detection unit to be input to an audio/image integration processing unit;

FIGS. 4A to 4C are explanatory diagrams for describing a basic processing example to which a particle filter is applied;

FIG. 5 is an explanatory diagram for describing configurations of particles set according to the present processing example;

FIG. 6 is an explanatory diagram for describing a configuration of target data of each of targets included in the respective particles;

FIG. 7 is an explanatory diagram for describing a configuration of target information and a generation processing;

FIG. 8 is an explanatory diagram for describing a configuration of the target information and the generation processing;

FIG. 9 is an explanatory diagram for describing a configuration of the target information and the generation processing;

FIG. 10 is a flowchart for describing a processing sequence executed by the audio/image integration processing unit;

FIG. 11 is an explanatory diagram for describing a detail of a particle weight calculation processing;

FIG. 12 is an explanatory diagram for describing a speaker identification processing to which face attribute information is applied; and

FIG. 13 is an explanatory diagram for describing the speaker identification processing to which the face attribute information is applied.

### DESCRIPTION OF THE PREFERRED EMBODIMENTS

Hereinafter, details of an information processing apparatus and an information processing method, and a computer program according to an embodiment of the present invention will be described with reference to the drawings.

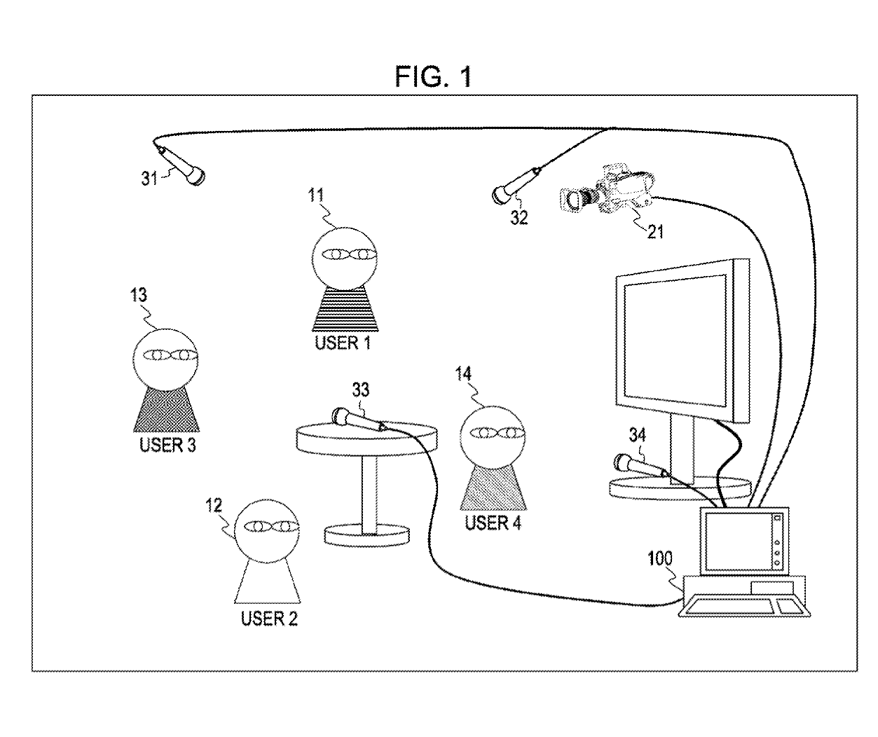

First, with reference to FIG. 1, a description will be given of an outline of a processing executed by the information processing apparatus according to an embodiment of the present invention. An information processing apparatus 100 according to the embodiment of the present invention inputs image information and audio information from sensors configured to input observation information in an actual space, herein, for example, a camera 21 and a plurality of microphones 31 to 34 and performs an environment analysis on the basis of these pieces of input information. To be more specific, an analysis on positions of a plurality of users 1 to 4 denoted by reference numerals 11 to 14 and an identification of the users located at the positions are performed.

In the example shown in the drawing, for example, when the users 1 to 4 denoted by reference numerals 11 to 14 are respectively factor, mother, sister, and brother of a family, the information processing apparatus 100 performs an analysis on the image information and the audio information input from the camera 21 and the plurality of microphones 31 to 34 to identify the positions of the four users 1 to 4 and which users at the respective positions are factor, mother, sister, and brother. The identification processing results are utilized for various processings. For example, the identification processing results are utilized for zooming up of the camera to the user who performs a discourse, an appropriate response to the user who performs the discourse, and the like.

It should be noted that main processings performed by the information processing apparatus 100 according to the embodiment of the present invention include a user position identification processing and a user identification processing as a user specification processing on the basis of the input information from the plurality of information input units (the camera 21 and the microphones 31 to 34). A purpose of this identification result utilization processing is not particularly limited. The image information and the audio information input from the camera 21 and the plurality of microphones 31 to 34 include various pieces of uncertain information. In the information processing apparatus 100 according to the embodiment of the present invention, a probabilistic processing is performed on the uncertain information included in these pieces of input information, and a processing of integrating information pieces estimated to have a high accuracy is performed. Through the estimation processing, the robustness is improved and the analysis with the high accuracy is performed.

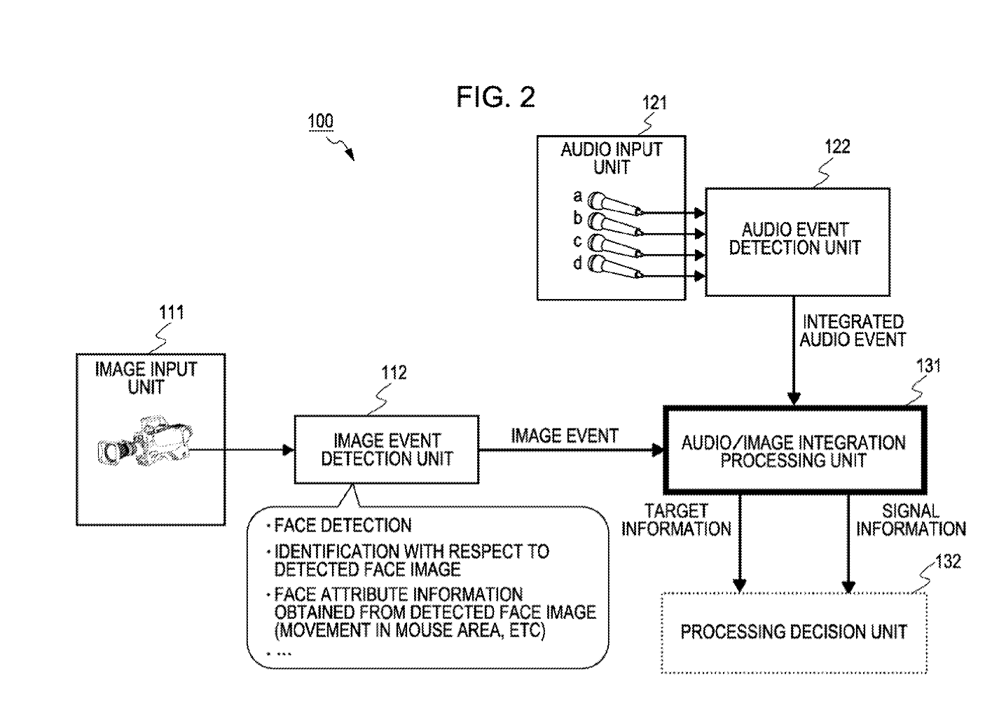

FIG. 2 illustrates a configuration example of the information processing apparatus 100. The information processing apparatus 100 includes the image input unit (camera) 111 and a plurality of audio input units (microphones) 121a to 121d as input devices. Image information is input from the image input unit (camera) 111, and audio information is input from the audio input unit (microphone) 121, so that the analysis is performed on the basis of these pieces of input information. The plurality of audio input units (microphones) 121a to 121d are respectively arranged at various positions as illustrated in FIG. 1.

The audio information input from the plurality of microphones 121a to 121d is input via an audio event detection unit 122 to an audio/image integration processing unit 131. The audio event detection unit 122 analyzes and integrates audio information input from the plurality of audio input units (microphones) 121a to 121d arranged at a plurality of different positions. To be more specific, on the basis of the audio information input from the audio input units (microphones) 121a to 121d, identification information indicating a position of generated audio and which user has generated the audio is generated and input to the audio/image integration processing unit 131.

It should be noted that a specific processing executed by the information processing apparatus 100 is, for example, a processing of performing, in an environment where a plurality of users exist as shown in FIG. 1, an identification as to where users A to D are located and which user performs a discourse, that is, the identification on the user position identification and the user identification, and further a processing of identifying an event generation source such as a person who emits voice (speaker).

The audio event detection unit 122 is configured to analyze audio information input from the plurality of audio input units (microphones) 121a to 121d located at plural different positions and generate position information on the audio generation source as probability distribution data. To be more specific, the expectation value and the variance data in the audio source direction N(mₑ, σₑ) is generated. Also, on the basis of the comparison processing with the characteristic information on the previously registered user voice, the user identification information is generated. This identification information is also generated as a probabilistic estimation value. In the audio event detection unit 122, pieces of characteristic information on voices of the users to be verified are previously registered. Through an execution of a comparison processing between the input audio and the registered audio, such a processing is performed of determining whether a probability that the voice is emitted from which user is high to calculate posterior probabilities or scores for all the registered users.

In this manner, the audio event detection unit 122 analyzes the audio information input from the plurality of audio input units (microphones) 121a to 121d arranged at the plural different positions to generate the position information of the audio generation source on the basis of [integration audio event information] composed of probability distribution data and identification information composed of probabilistic estimation values to be input to the audio/image integration processing unit 131.

On the other hand, the image information input from the image input unit (camera) 111 is input via an image event detection unit 112 to the audio/image integration processing unit 131. The image event detection unit 112 is configured to analyze the image information input from the image input unit (camera) 111 to extract a face of a person included in the image, and generates face position information as the probability distribution data. To be more specific, the expectation value and the variance data related to the position and the direction of the face N(mₑ, σₑ) is generated.

In addition, the image event detection unit 112 identifies the face on the basis of the comparison processing with the previously registered characteristic information on the user face and generates the user identification information. This identification information is also generated as a probabilistic estimation value. In the image event detection unit 112, pieces of characteristic information on faces of a plurality of users to be verified are previously registered. Through a comparison processing between the characteristic information on the image of the face area extracted from the input image and the previously registered face image characteristic information, a processing of determining whether a probability that the face is of which user is high to calculate posterior probabilities or scores for all the registered users.

Furthermore, the image event detection unit 112 calculates an attribute score corresponding to the face included in the image input from the image input unit (camera) 111, for example, a face attribute score generated on the basis of the motion of the mouth area.

The face attribute score can be set, for example, as the following various face attribute scores.

(a) A score corresponding to the motion of the mouth area of the face included in the image

(b) A score corresponding to whether or not the face included in the image is a smiling face

(c) A score set in accordance with whether the face included in the image is a man or a woman

(d) A score set in accordance with whether the face included in the image is an adult or a child

In an embodiment described below, an example is provided in which the face attribute score is calculated and utilized as (a) the score corresponding to the motion of the mouth area of the face included in the image. That is, the score corresponding to the motion of the mouth area of the face is calculated as the face attribute score, the speaker is identified on the basis of the face attribute score.

The image event detection unit 112 identifies the mouth area from the face area included in the image input from the image input unit (camera) 111. Then, the motion detection of the mouth area is performed, and the score corresponding to the motion detection result of the mouth area is calculated. For example, a high score is calculated in a case where it is determined that there is a mouth motion.

It should be noted that the processing of detecting the motion of the mouth area is executed, for example, as a processing to which VSD (Visual Speech Detection) is applied. It is possible to apply a method disclosed in Japanese Unexamined Patent Application Publication No. 2005-157679 of the same applicant as the present invention. To be more specific, for example, left and right end points of the lip are detected from the face image which is detected from the input image from the image input unit (camera) 111. In an N-th frame and an N+1-th frame, the left and right end points of the lip are aligned, and then a difference in luminance is calculated. By performing a threshold processing on this difference value, it is possible to detect the mouth motion.

It should be noted that related art technologies are applied for the audio identification processing, the face detection processing, and the face identification processing executed in the audio event detection unit 122 and the image event detection unit 112. For example, it is possible to apply technologies disclosed in the following documents as the face detection processing and the face identification processing.

Kohtaro Sabe and Ken'ichi Idai, “Real-time multi-view face detection using pixel difference feature”, Proceedings of the 10th Symposium on Sensing via Imaging Information, pp. 547-552, 2004

Japanese Unexamined Patent Application Publication No. 2004-302644 [Title of the Invention: face identification apparatus, face identification method, recording medium, and robot apparatus]

The audio/image integration processing unit 131 executes a processing of probabilistically estimating each of the plurality of users is located where, the user is who, and a signal such as voice is emitted by whom on the basis of the input information from the audio event detection unit 122 and the image event detection unit 112. This processing will be described in detail below. On the basis of the input information from the audio event detection unit 122 and the image event detection unit 112, the audio/image integration processing unit 131 outputs (a) [target information] as the estimation information that each of the plurality of users is located where and the user is who, and (b) an event generation source such as a user who performs the discourse, for example, as [signal information] to the processing decision unit 132.

The processing decision unit 132 receiving these identification processing results executes a processing in which the identification processing results are utilized, for example, zooming up of the camera to the user who performs a discourse, a response from the television to the user who performs the discourse, and the like.

As described above, the audio event detection unit 122 generates the probability distribution data on the position information of the audio generation source, to be more specific, the expectation value and the variance data in the audio source direction N(mₑ, σₑ). Also, on the basis of the comparison processing with the characteristic information on the previously registered user voice, the user identification information is generated and input to the audio/image integration processing unit 131.

In addition, the image event detection unit 112 extracts and generates a face of a person included in the image as face position information as the probability distribution data. To be more specific, the expectation value and the variance data related to the position and the direction of the face N(mₑ, σₑ) are generated. Also, on the basis of the comparison processing with the previously registered characteristic information on the user face, the user identification information is generated and input to the audio/image integration processing unit 131. Furthermore, the face attribute score is calculated as the face attribute information in the image input from the image input unit (camera) 111. The score is, for example, a score corresponding to the motion detection result of the mouth area after the motion detection of the mouth area is performed. To be more specific, the face attribute score is calculated in such a manner that a high score is calculated in a case where it is determined that the mouth motion is large, and the face attribute score is input to the audio/image integration processing unit 131.

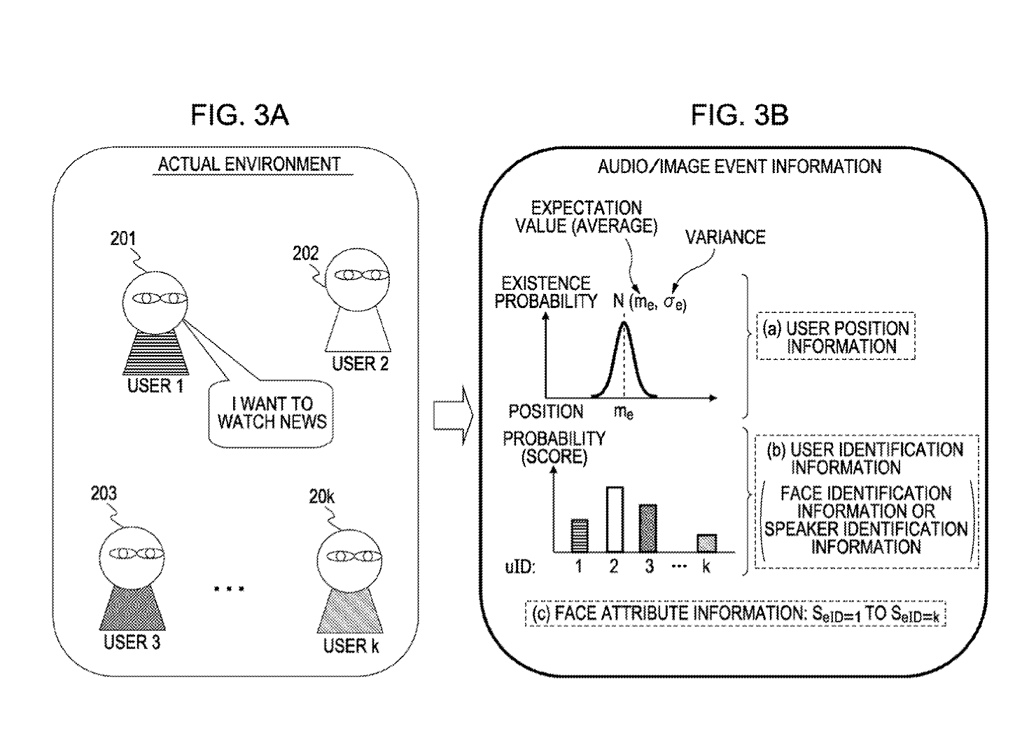

With reference to FIGS. 3A and 3B, a description will be given of information examples generated by the audio event detection unit 122 and the image event detection unit 112 and input to the audio/image integration processing unit 131.

In the configuration according to the embodiment of the present invention, the image event detection unit 112 generates the following data and inputs these pieces of data to the audio/image integration processing unit 131.

(Va) The expectation value and the variance data related to the position and the direction of the face N(mₑ, σₑ)

(Vb) The user identification information based on the characteristic information of the face image

(Vc) The score corresponding to the attribute of the detected face, for example, the face attribute score generated on the basis of the motion of the mouth area

Then, the audio event detection unit 122 inputs the following data to the audio/image integration processing unit 131.

(Aa) The expectation value and the variance data in the audio source direction N(mₑ, σₑ)

(Ab) The user identification information based on the characteristic information of the voice

FIG. 3A illustrates an actual environment example in which the camera and microphones similar to those described with reference to FIG. 1 are provided, and a plurality of users 1 to k denoted by reference numerals 201 to 20k exist. In this environment, when a certain user has a discourse, the audio is input through the microphone. Also, the camera continuously picks up images.

The information generated by the audio event detection unit 122 and the image event detection unit 112 and input to the audio/image integration processing unit 131 is roughly divided into the following three types.

(a) The user position information

(b) The user identification information (the face identification information or the speaker identification information)

(c) The face attribute information (the face attribute score)

That is, (a) the user position information is integrated data of the following data.

(Va) The expectation value and the variance data related to the position and the direction of the face N(mₑ, σₑ) generated by the image event detection unit 112.

(Aa) The expectation value and the variance data in the audio source direction N(mₑ, σₑ) generated by the audio event detection unit 122

In addition, (b) the user identification information (the face identification information or the speaker identification information) is integrated data of the following data.

(Vb) The user identification information based on the characteristic information of the face image generated by the image event detection unit 112

(Ab) The user identification information based on the characteristic information of the voice generated by the audio event detection unit 122

(c) The face attribute information (the face attribute score) is integrated data of the following data.

(Vc) The score corresponding to the attribute of the detected face generated by the image event detection unit 112, for example, the face attribute score generated on the basis of the motion of the mouth area

The following three pieces of are generated each time when an event is caused.

(a) The user position information

(b) The user identification information (the face identification information or the speaker identification information)

(c) The face attribute information (the face attribute score)

The audio event detection unit 122 generates (a) the user position information and (b) the user identification information described above on the basis of the audio information in a case where the audio information is input from the audio input units (microphones) 121a to 121d and inputs (a) the user position information and (b) the user identification information to the audio/image integration processing unit 131. The image event detection unit 112 generates (a) the user position information, (b) the user identification information, and (c) the face attribute information (the face attribute score), for example, at a constant frame interval previously determined on the basis of the image information input from the image input unit (camera) 111 and inputs (a) the user position information, (b) the user identification information, and (c) the face attribute information (the face attribute score) to the audio/image integration processing unit 131. It should be noted that according to the present example, the description has been given of such a setting that one camera is set as the image input unit (camera) 111, and images of a plurality of users are captured by the one camera. In this case, (a) the user position information and (b) the user identification information are generated for each of the plurality of faces included in one image and input to the audio/image integration processing unit 131.

A description will be given of a processing performed by the audio event detection unit 122 of generating the following information on the basis of the audio information input from the audio input units (microphones) 121a to 121d.

(a) The user position information

(b) The user identification information (speaker identification information)

### [Generation Processing for (a) the User Position Information Performed by the Audio Event Detection Unit 122]

The audio event detection unit 122 generates estimation information on the position of the user who emits the voice analyzed on the basis of the audio information input from the audio input units (microphones) 121a to 121d, that is, [the speaker]. That is, the position where the speaker is estimated to exist is generated as the Gauss distribution (normal distribution) data N(mₑ, σₑ) composed of the expectation value (average) [mₑ] and the variance information [σₑ].

### [Generation Processing Performed by the Audio Event Detection Unit 122 for (b) the User Identification Information (Speaker Identification Information)]

The audio event detection unit 122 estimates who is the speaker on the basis of the audio information input from the audio input units (microphones) 121a to 121d through a comparison processing between the input audio and the previously registered characteristic information on the voices of the users 1 to k. To be more specific, the probabilities that the respective speakers are the users 1 to k are used. This calculation value is set as (b) the user identification information (speaker identification information). For example, such a processing is performed that the highest score is allocated to the user who has the registered audio characteristic most close to the characteristic of the input audio, the lowest score (for example, 0) is allocated to the user who has the registered audio characteristic most different from the characteristic of the input audio, and the data setting the probabilities that the respective speakers are the users is generated. This is set as (b) the user identification information (speaker identification information).

Next, a description will be given of a processing performed by the image event detection unit 112 of generating these pieces of information on the basis of the image information input from the image input unit (camera) 111.

(a) The user position information

(b) The user identification information (the face identification information)

(c) The face attribute information (the face attribute score)

### [Generation Processing Performed by [the Image Event Detection Unit 112 for (a) the User Position Information]

The image event detection unit 112 generates the estimation information on the positions of the respective faces included in the image information input from the image input unit (camera) 111. That is, data on the positions where the faces detected from the image exist is generated as the Gauss distribution (normal distribution) data N(mₑ, σₑ) composed of the expectation value (average) [mₑ] and the variance information [σₑ].

### [Generation Processing Performed by the Image Event Detection Unit 112 for (b) the User Identification Information (the Face Identification Information)]

The image event detection unit 112 detects the face included in the image information on the basis of the image information input from the image input unit (camera) 111 and estimates the respective faces are whose faces through the comparison processing between the input image information and the previously registered characteristic information on the faces of the users 1 to k. To be more specific, the probabilities that the respective extracted faces are the users 1 to k are calculated. This calculation value is set as (b) the user identification information (the face identification information). For example, such a processing is performed that the highest score is allocated to the user who has the registered face characteristic most close to the characteristic of the face included in the input image, the lowest score (for example, 0) is allocated to the user who has the registered face characteristic most different from the characteristic of the face included in the input image, and the data setting the probabilities that the respective speakers are the users is generated. This is set as (b) the user identification information (the face identification information).

### [Generation Processing Performed by the Image Event Detection Unit 112 for (c) the Face Attribute Information (the Face Attribute Score)]

The image event detection unit 112 can detect the face area included in the image information on the basis of the image information input from the image input unit (camera) 111, and can calculate the attributes of the detected respected faces. To be more specific, as described above, the attribute scores include the score corresponding to the motion of the mouth area, the score corresponding to whether or not the face is the smiling face, the score set in accordance with whether the face is a man or a woman, and the score set in accordance with whether the face is an adult or a child. According to the present processing example, the case is described in which the score corresponding to the motion of the mouth area of the face included in the image is calculated and utilized as the face attribute score.

As a processing of calculating the score corresponding to the motion of the mouth area of the face, as described above, the image event detection unit 112 detects, for example, left and right end points of the lip from the face image which is detected from the input image from the image input unit (camera) 111. In an N-th frame and an N+1-th frame, the left and right end points of the lip are aligned, and then a difference in luminance is calculated. By performing a threshold processing on this difference value, it is possible to detect the mouth motion. The higher face attribute score is set as the mouth motion is larger.

It should be noted that in a case where a plurality of faces are detected from the picked up image of the camera, the image event detection unit 112 generates event information corresponding to the respective faces as the independent event in accordance with the respective detected faces. That is, the event information including the following information is generated and input to the audio/image integration processing unit 131.

(a) The user position information

(b) The user identification information (the face identification information)

(c) The face attribute information (the face attribute score)

According to the present example, the description is given of the case where one camera is utilized as the image input unit 111, picked up images of a plurality of cameras may be utilized. In that case, the image event detection unit 112 generates the following information for the respective faces in the picked up images of the cameras to input to the audio/image integration processing unit 131.

(a) The user position information

(b) The user identification information (the face identification information)

(c) The face attribute information (the face attribute score)

Next, a processing executed by the audio/image integration processing unit 131 will be described. As described above, the audio/image integration processing unit 131 sequentially inputs from the audio event detection unit 122 and the image event detection unit 112, the following three pieces of information illustrated in FIG. 3B.

(a) The user position information

(b) The user identification information (the face identification information or the speaker identification information)

(c) The face attribute information (the face attribute score)

It should be noted that various settings can be adopted on the input timings for these pieces of information. For example, in a case where a new audio is input, the audio event detection unit 122 generates the above-mentioned respective information pieces (a) and (b) as the audio event information, the image event detection unit 112 generates and inputs the above-mentioned respective information pieces (a), (b), and (c) as the audio event information in units of a certain frame cycle.

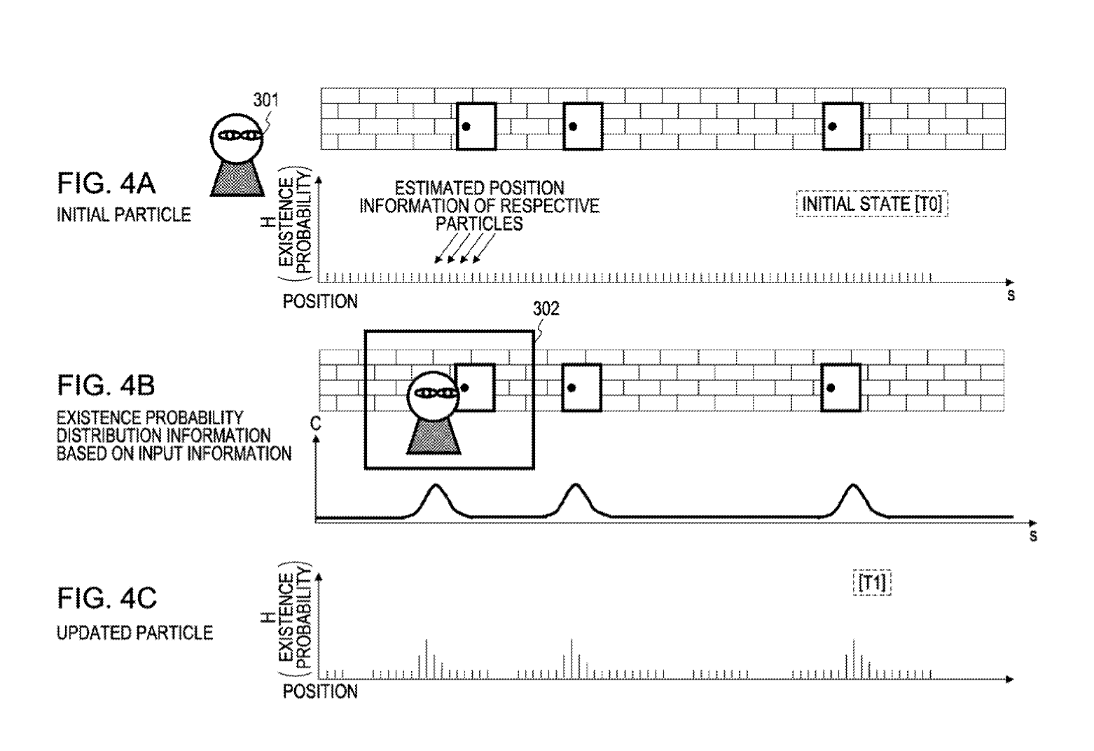

A processing executed by the audio/image integration processing unit 131 will be described with reference to FIG. 4 and subsequent figures. The audio/image integration processing unit 131 performs a processing of setting the probability distribution data on the hypothesis regarding the user position and identification information and updating the hypothesis on the basis of the input information, so that only more plausible hypothesis is remained. As this processing method, the processing to which the particle filter is applied is executed.

The processing to which the particle filter is applied is performed by setting a large number of particles corresponding to various hypotheses. According to the present example, a large number of particles are set corresponding to hypotheses in which the users are located where and who the users are. From the audio event detection unit 122 and the image event detection unit 112, on the basis of the following three pieces of input information illustrated in FIG. 3B, the processing of increasing the weight of more plausible particle is performed.

(a) The user position information

(b) The user identification information (the face identification information or the speaker identification information)

(c) The face attribute information (the face attribute score)

The basic processing to which the particle filter is applied will be described with reference to FIG. 4. For example, in the example illustrated in FIG. 4, the processing example of estimating the existing position corresponding to a certain user by way of the particle filters. The example illustrated in FIG. 4 is a processing of estimating the position where a user 301 exists in a one-dimensional area on a certain straight line.

The initial hypothesis (H) is uniform particle data as illustrated in FIG. 4A. Next, image data 302 is obtained, the existing probability distribution data on the user 301 based on the obtained image is obtained as data of FIG. 4B. On the basis of the probability distribution data based on the obtained image, the particle distribution data of FIG. 4A is updated, and the updated hypothesis probability distribution data of FIG. 4C is obtained. Such a processing is repeatedly executed on the basis of the input information to obtain more plausible user position information.

It should be noted that a detail of the processing using the particle filter is described, for example, in [D. Schulz, D. Fox, and J. Hightower. People Tracking with Anonymous and ID-sensors Using Rao-Blackwellised Particle Filters. Proc. of the International Joint Conference on Artificial Intelligence (IJCAI-03)].

The processing example illustrated in FIGS. 4A to 4C is described as a processing example in which only the input information is set as the image data regarding the user existing position, and the respective particles have only the existing position information on the user 301.

On the other hand, on the basis of the following two pieces of information illustrated in FIG. 3B from the audio event detection unit 122 and the image event detection unit 112, the processing is performed of determining the plurality of users are located where and who the plurality of users are.

(a) The user position information

(b) The user identification information (the face identification information or the speaker identification information)

Therefore, in the processing to which the particle filter is applied, the audio/image integration processing unit 131 sets a large number of particles corresponding to hypotheses in which the users are located where and who the users are. On the basis of the two pieces of information illustrated in FIG. 3B from the audio event detection unit 122 and the image event detection unit 112, the particle update is performed.

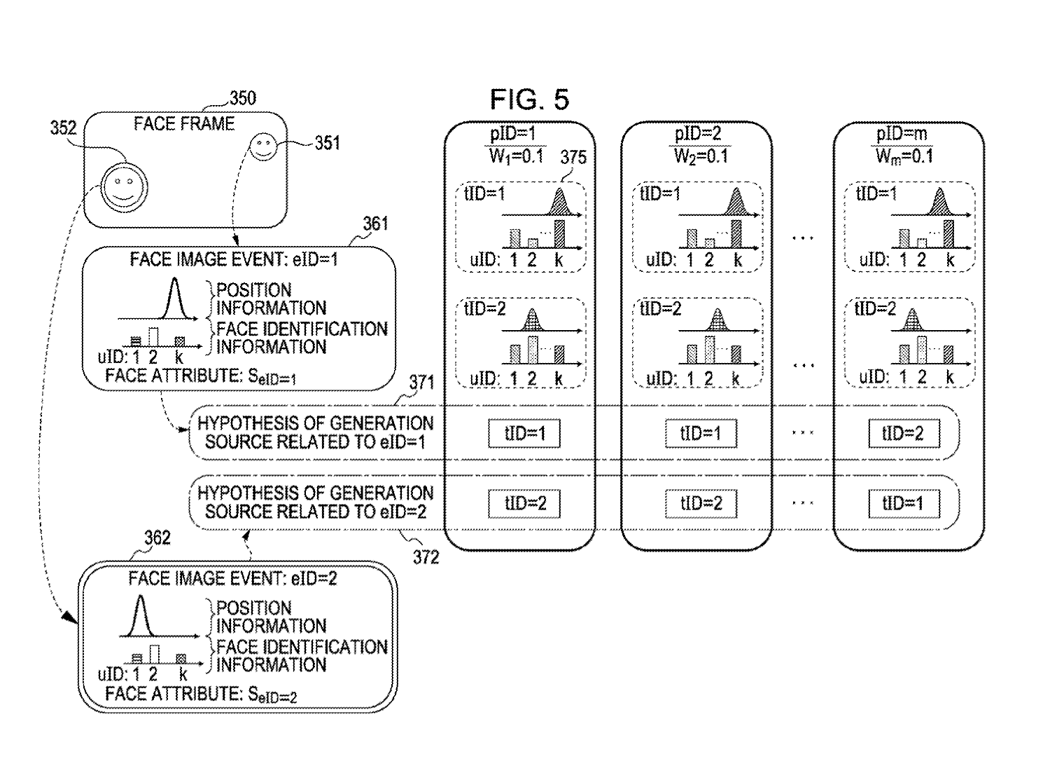

The particle update processing example executed by the audio/image integration processing unit 131 will be described with reference to FIG. 5 in which the audio/image integration processing unit 131 inputs the three pieces of information illustrated in FIG. 3B from the audio event detection unit 122 and the image event detection unit 112.

(a) The user position information

(b) The user identification information (the face identification information or the speaker identification information)

(c) The face attribute information (the face attribute score)

A particle configuration will be described. The audio/image integration processing unit 131 has the previously set number (=m) of particles. The particles illustrated in FIG. 5 are particles 1 to m. In the respective particles, particle IDs (PID=1 to m) functioning as an identifier are set.

In the respective particles, a plurality of targets tID=1, 2, . . . n corresponding to virtual objects are set. According to the present example a plurality of (n) targets corresponding to virtual users equal to or larger than the number of people estimated to exist in the real space, for example, are set. The respective m particles holds data for the number of targets in units of target. According to the example illustrated in FIG. 5, one particle includes n targets (n=2).

The audio/image integration processing unit 131 inputs from the audio event detection unit 122 and the image event detection unit 112, the following event information illustrated in FIG. 3B, and performs the update processing on m particles (PID=1 to m).

(a) The user position information

(b) The user identification information (the face identification information or the speaker identification information)

(c) The face attribute information (the face attribute score [S_{eID}])

The respective targets 1 to n included the particles in 1 to m set by the audio/image integration processing unit 131 illustrated in FIG. 5 are previously associated with the pieces of input event information (eID=1 to k), and in accordance with the association, the update of the selected target corresponding to the input event is executed. To be more specific, for example, such a processing is performed that the face image detected in the image event detection unit 112 is set as the individual event, and the targets are associated with the respective face image events.

The specific update processing will be described. For example, at a predetermined constant frame interval, on the basis of the image information input from the image input unit (camera) 111, the image event detection unit 112 generates (a) the user position information, (b) the user identification information, and (c) the face attribute information (the face attribute score) to be input to the audio/image integration processing unit 131.

At this time, in a case where an image frame 350 illustrated in FIG. 5 is an event detection target frame, the event in accordance with the number of face images included in the image frame is detected. That is, an event 1 (eID=1) corresponding to a first face image 351 illustrated in FIG. 5 and an event 2 (eID=2) corresponding to a second face image 352.

The image event detection unit 112 generates the following information to be input to the audio/image integration processing unit 131 regarding the respective events (eID=1, 2, . . . ).

(a) The user position information

(b) The user identification information (the face identification information or the speaker identification information)

(c) The face attribute information (the face attribute score)

That is, the event corresponding information 361 and 362 shown in FIG. 5.

Such a configuration is adopted that the targets 1 to n of the particles 1 to m set by the audio/image integration processing unit 131 are respectively associated with the events (eID=1 to k) in advance, and which target in the respective particles is updated is previously set. It should be noted that such a setting is adopted that the associations of the targets (tID) with the respective events (eID=1 to k) are not overlapped. That is, the same number of event generation source hypotheses as the obtained events are generated so as to avoid the overlap in the respective particles.

In the example shown in FIG. 5, (1) the particle 1 (pad=1) has the following setting.

The corresponding target of [Event ID=1 (eID=1)]=[the target ID=1 (tID=1)]

The corresponding target of [Event ID=2 (eID=2)]=[the target ID=2 (tID=2)]

(2) The particle 2 (pad=2) has the following setting.

The corresponding target of [Event ID=1 (eID=1)]=[the target ID=1 (tID=1)]

The corresponding target of [Event ID=2 (eID=2)]=[the target ID=2 (tID=2)]

(m) The particle m(pad=m) has the following setting.

The corresponding target of [Event ID=1 (eID=1)]=[the target ID=2 (tID=2)]

The corresponding target of [Event ID=2 (eID=2)]=[the target ID=1 (tID=1)]

In this manner, such a configuration is adopted that the respective targets 1 to n included in the particles 1 to m set by the audio/image integration processing unit 131 are previously associated with the events (eID=1 to k), and it is decided as to which target is updated included in the respective particles in accordance with the respective event IDs. For example, in the particle 1 (pID=1), the event corresponding information 361 of [Event ID=1 (eID=1)] shown in FIG. 5 only selectively updates the data of the target ID=1 (tID=1).

Similarly, in the particle 2 (pID=2) too, the event corresponding information 361 of [Event ID=1 (eID=1)] shown in FIG. 5 only selectively updates the data of the target ID=1 (tID=1). Also, in the particle m (pID=m), the event corresponding information 361 of [Event ID=1 (eID=1)] shown in FIG. 5 only selectively updates the data of the target ID=2 (tID=2).

Event generation source hypothesis data 371 and 372 shown in FIG. 5 are event generation source hypothesis data set in the respective particles. These pieces of event generation source hypothesis data are set in the respective particles, and the update target corresponding to the event ID is decided while following this information.

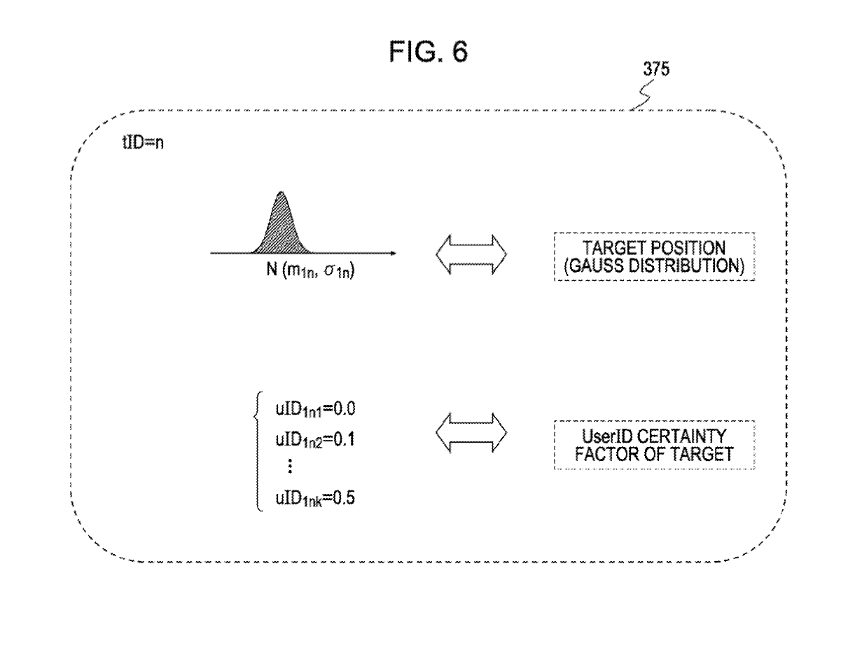

The target data included in the respective particles will be described with reference to FIG. 6. FIG. 6 illustrates a configuration of target data on one of the targets (target ID: tID=n) 375 included in the particle 1 (pID=1) illustrated in FIG. 5. The target data of the target 375 is composed of the following data as shown in FIG. 6.

(a) Probability distribution of the existing positions corresponding to the respective targets [the Gauss distribution: N(m₁ₙ, σ₁ₙ)]

(b) User certainty factor information (uID) indicating who the respective targets are
aid_{ing}=0.0
uID₁ₙ₂=0.1
uID₁ₙₖ=0.5

It should be noted that (1n) of [m₁ₙ, σ₁ₙ] in the Gauss distribution: N(m₁ₙ, σ₁ₙ) illustrated in (a) means the Gauss distribution as the existing probability distribution corresponding to the target ID: tID=n in the particle ID: pID=1.

In addition, (1n1) included in [uID₁ₙ₁] in the user certainty factor information (uID) illustrated in (b) means the probability of the user=the user 1 of the target ID: tID=n in the particle ID: pID=1. That is, the data of the target ID=n means as follows.
The probability that the user is the user 1 is 0.0
The probability that the user is the user 2 is 0.1
The probability that the user is the user k is 0.5

Referring back to FIG. 5, the description will be continued of the particle set by the audio/image integration processing unit 131. As illustrated FIG. 5, the audio/image integration processing unit 131 sets the previously decided number (=m) of the particles (PID=1 to m). The respective targets (tID=1 to n) estimated to exist in the real space has the following target data:

(a) The probability distribution of the existing positions corresponding to the respective targets [the Gauss distribution: N(m, σ)]; and

(b) The user certainty factor information (uID) indicating who the respective targets are.

The audio/image integration processing unit 131 inputs from the audio event detection unit 122 and the image event detection unit 112, the following event information (eID=1, 2, . . . ) illustrated in FIG. 3B, and executes the update of the targets corresponding to the previously set events in the respective particles.

(a) The user position information

(b) The user identification information (the face identification information or the speaker identification information)

(c) The face attribute information (the face attribute score [S_{eID}]

It should be noted that the update targets are the following data included in the respective pieces of target data.

(a) The user position information

(b) The user identification information (the face identification information or the speaker identification information)

Then, (c) The face attribute information (the face attribute score [S_{eID}]) is eventually utilized as [the signal information] indicating the event generation source. When a certain number of events are input, the weights of the respective particles are also updated. The weight of the particle having the information most close to the information in the real space becomes larger, and the weight of the particle having the information which is not matched to the information in the real space becomes smaller. At a stage where a bias is generated and then converged in the weights of the particles, the signal information based on the face attribute information (the face attribute score), that is, [the signal information] indicating the event generation source is calculated.

The probability that the certain target x (tID=x) is the generation source of a certain event (eID=y) is represented as follows.

P_{eID=x}(tID=y)

For example, as illustrated FIG. 5, the m particles (pID=1 to m) are set, and in a case where two targets (tID=1, 2) are set in the respective particles, the probability that the first target (tID=1) is the generation source of the first event (eID=1) is P_{eID=1}(tID=1), and the probability that the second target (tID=2) is the generation source of the first event (eID=1) is P_{eID=1}(tID=2).

Also, the probability that the first target (tID=1) is the generation source of the second event (eID=2) is P_{eID=2}(tID=1), and the probability that the second target (tID=2) is the second event (eID=2) is P_{eID=2}(tID=2).

[The signal information] indicating the event generation source is the probability that the generation source of a certain event (eID=y) is a particular target x (tID=x), which is represented as follows.

P_{eID=x}(tID=y)

This is equivalent to the ratio of the number of particles (m) set by the audio/image integration processing unit 131 to the number of targets assigned to the respective events. In the example shown in FIG. 5, the following corresponding relation is established.

P_{eID=1}(tID=1)=[the number of particles in which the first event (eID=1) is assigned as tID=1/(m)]

P_{eID=1}(tID=2)=[the number of particles in which the first event (eID=1) is assigned as tID=2/(m)]

P_{eID=2}(tID=1)=[the number of particles in which the second event (eID=2) is assigned as tID=1/(m)]

P_{eID=2}(tID=2)=[the number of particles in which the second event (eID=2) is assigned as tID=2/(m)]

This data is eventually utilized as [the signal information] indicating the event generation source.

Furthermore, the probability that the generation source of a certain event (eID=y) is a particular target x (tID=x), which is represented as follows.

P_{eID=x}(tID=y)

This data is also applied to the calculation for the face attribute information included in the target information. That is, the data is also utilized for calculating the face attribute information S_{tID=1 to n}. The face attribute information S_{tID=x} is equivalent to the final face attribute expectation value for the value the target of the target ID=x, that is, the probability value of being the speaker.

The audio/image integration processing unit 131 inputs the event information (eID=1, 2, . . . ) from the audio event detection unit 122 and the image event detection unit 112 and executes the update of the event corresponding targets previously set in the respective particles. Then the audio/image integration processing unit 131 generates the following data to be output to the processing decision unit 132.

(a) [The target information] including the position estimated information the plurality of users are located where, the estimated information (uID estimated information) indicating who the users are, and furthermore, the expectation value of the face attribute information (S_{tID}), for example, the face attribute expectation value indicating that a mouth is moved to have a discourse

(b) [The signal information] indicating the event generation source, for example, the user who has a discourse

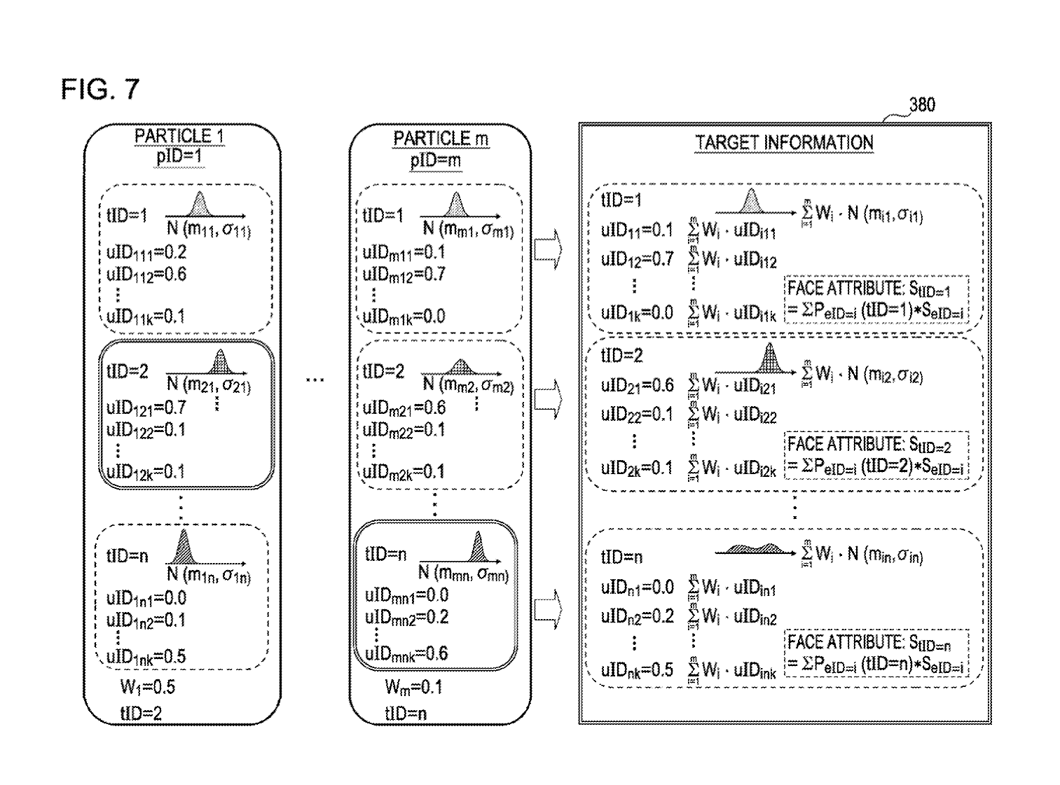

As illustrated in target information 380 on the right end of FIG. 7, [the target information] is generated as the weighting total sum data of the data corresponding to the respective targets (tID=1 to n) included in the respective particles (PID=1 to m). FIG. 7 illustrates the m particles (pID=1 to m) of the audio/image integration processing unit 131 and the target information 380 generated from these m particles (pad=1 to m). The weight of the respective particles will be described below.

The target information 380 indicates the following information of the targets (tID=1 to n) corresponding to the virtual uses previously set by the audio/image integration processing unit 131.

(a) The existing position

(b) Who the user is (which one of uID1 to uIDk)

(c) The face attribute expectation value (according to the present processing example, the expectation value (probability) that the user is the speaker)

As described above, (c) the face attribute expectation value (according to the present processing example, the expectation value (probability) that the user is the speaker) of the respective targets is calculated on the basis of the probability equivalent to [the signal information] indicating the event generation source P_{eID=x}(tID=y) and the face attribute score S_{eID=i} corresponding to the respective events. Denoted by i is an event ID.

For example, the face attribute expectation value of the target ID=1: S_{tID=1} is calculated by the following expression.

S_{tID=1}=Σ_{eID}P_{eID=i}(tID=1)×S_{eID=i}

To be generalized, the face attribute expectation value of the target: S_{tID} is calculated by the following expression.

S_{tID}=Σ_{eID}P_{eID=i}(tID)×S_{eID} (Expression 1)

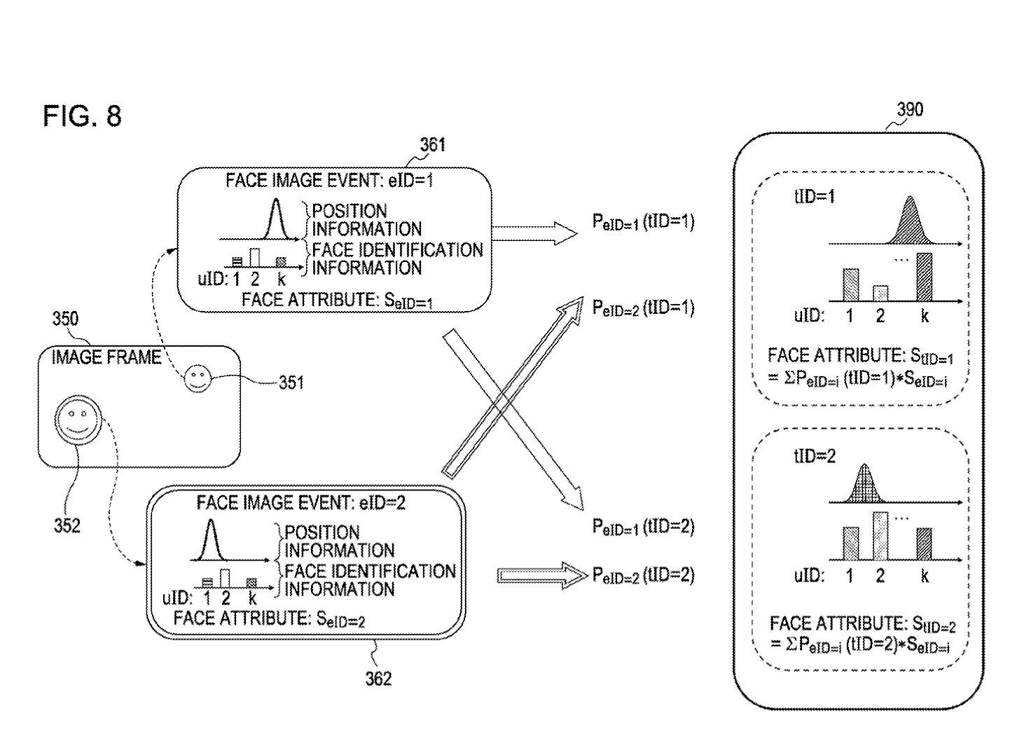

For example, as illustrated FIG. 5, in a case where two targets exist inside the system, FIG. 8 illustrates the face attribute expectation value calculation example of the respective targets (tID=1, 2) when two face image events (eID=1, 2) are input from the image event detection unit 112 in image one frame to the audio/image integration processing unit 131.

Data on the right end of FIG. 8 is target information 390 which is equivalent to the target information 380 illustrated in FIG. 7. The target information 390 is equivalent to information generated as the weighting total sum data of the data corresponding to the respective targets (tID=1 to n) included in the respective particles (PID=1 to m).

As described above, the face attribute of the respective targets in the target information 390 is calculated on the basis of the probability [P_{eID=x}(tID=y)] equivalent to [the signal information] indicating the event generation source and the face attribute score [S_{eID=i}] corresponding to the respective events. Denoted by i is an event ID.

The face attribute expectation value of the target ID=1: S_{tID=1} is represented as follows.

S_{tID=1}=Σ_{eID}P_{eID=i}(tID=1)×S_{eID=i}

The face attribute expectation value of the target ID=2: S_{tID=2} is represented as follows.

S_{tID=2}=Σ_{eID}P_{eID=i}(tID=2)×S_{eID=i}

The total sum of the face attribute expectation value of the respective targets: S_{tID} for all the targets becomes [1]. According to the present processing example, regarding the respective targets, the face attribute expectation value 1 to 0: S_{tID} is set, and it is determined that the probability is high that the target with a large expectation value is the speaker.

It should be noted that in a case where the face attribute score[S_{eID}] does not exist in the face image event eID, (for example, in a case where the face detection can be performed but the mouth is covered by a hand and the mouth motion detection is difficult to perform), a prior knowledge value [Sₚᵣᵢₒᵣ] or the like is used for the face attribute score[S_{eID}]. For the prior knowledge value, such a configuration can be adopted that in a case where when the value exists which is just obtained for each of the respective targets, the value is used, or a calculation for an average value of the face attributes previously obtained off line from the face image event is performed, and the average value is used.

The number of targets and the number of face image events in image one frame may not be the same in some cases. When the number of targets is larger than the number of face image events, the total sum of the probabilities [P_{eID}(tID)] equivalent to [the signal information] indicating the event generation source described above does not become [1]. Thus, the above-mentioned face attribute expectation value calculation expression of the respective targets. That is, the total sum of the expectation values of the respective targets in the following expression also does not become [1].

S_{tID}=Σ_{eID}P_{eID=i}(tID)×S_{eID} (Expression 1)

Thus, the expectation values with a high accuracy are not calculated.

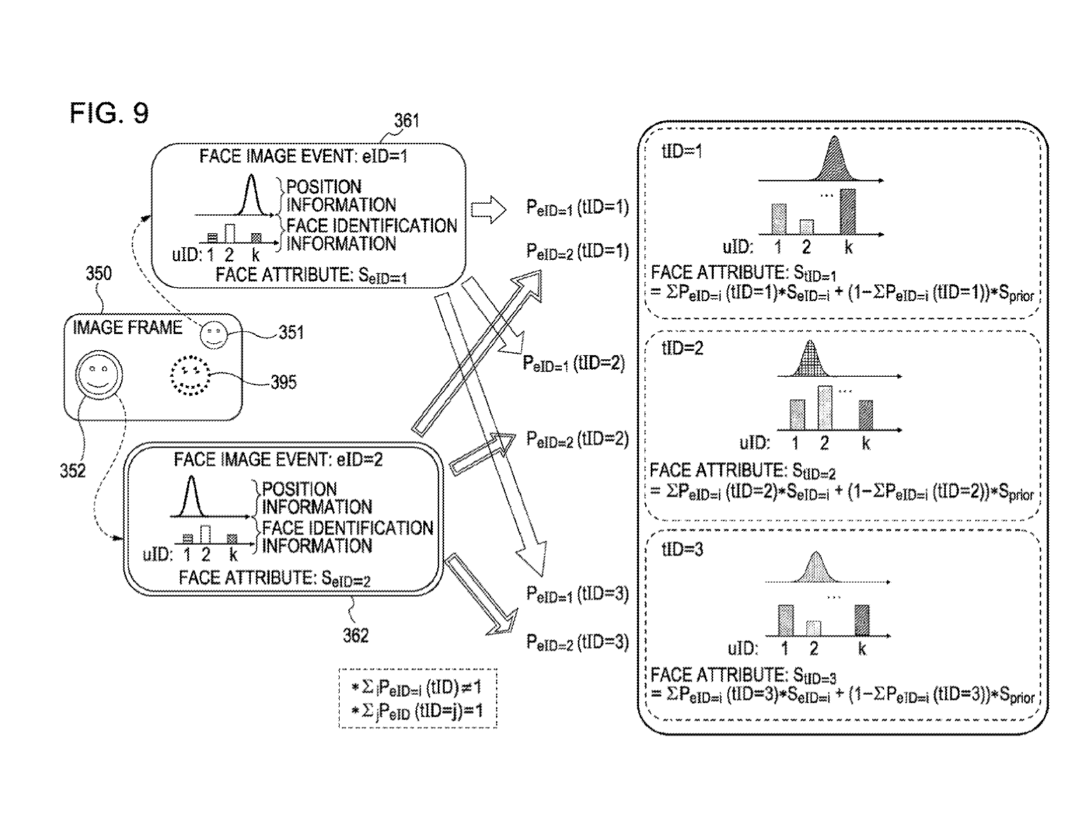

As illustrated in FIG. 9, in a case where a third face image 395 corresponding to the third event existing in the previous processing frame in the image frame 350 is not detected, the total sum of the expectation values of the respective targets of the above-mentioned expression (Expression 1) also does not become [1], and the expectation values with a high accuracy are not calculated. In such a case, the face attribute expectation value calculation expression of the respective targets is changed. That is, in order that the total sum of the face attribute expectation value [S_{tiD}] of the respective targets is set as [1], a complement number [1−Σ_{eID}P_{eID}(tID)] and the prior knowledge value [Sₚᵣᵢₒᵣ] are used to calculate the expectation value of the face event attribute S_{tID} through the following expression (Expression 2).

S_{tID}=Σ_{eID}P_{eID}(tID)×S_{eID}+(1−Σ_{eID}P_{eID}(tID))×Sₚᵣᵢₒᵣ (Expression 2)

FIG. 9 illustrates an face attribute expectation value calculation example in which three event corresponding targets are set inside the system, but only two event corresponding targets are input from the image event detection unit 112 to the audio/image integration processing unit 131 as the face image events in the image one frame.

The face attribute expectation value of the target ID=1: S_{tID=1} is calculated as follows.

S_{tID=1}=Σ_{eID}P_{eID=i}(tID=1)×S_{eID=i}+(1−Σ_{eID}P_{eID}(tID=1)×Sₚᵣᵢₒᵣ

The face attribute expectation value of the target ID=2: S_{tID=2} is calculated as follows.

S_{tID=2}=Σ_{eID}P_{eID=i}(tID=2)×S_{eID=1}+(1−Σ_{eID}P_{eID}(tID=2)×Sₚᵣᵢₒᵣ

The face attribute expectation value of the target ID=3: S_{tID=3} is calculated as follows.

S_{tID=3}=Σ_{eID}P_{eID=i}(tID=3)×S_{eID=i}+(1−Σ_{eID}P_{eID}(tID=3)×Sₚᵣᵢₒᵣ

It should be noted that, on the contrary, when the number of targets is smaller than the number of face image events, in order that the number of targets is set as the same number of events, the target is generated. By applying the above-mentioned (Expression 1), the face attribute expectation value [S_{tID=1}] of the respective targets is calculated.

It should be noted that, according to the present processing example, the face attribute has been described as the face attribute expectation value based on the score corresponding to the mouth motion, that is, the data indicating the expectation value that the respective targets are the speakers. However, as described above, the face attribute score can be calculated as the score for a smiling face, an age, or the like. In this case, the face attribute expectation value is calculated as data corresponding to the attribute which corresponds to the score.

The target information is sequentially updated along with the particle update. For example, in a case where the users 1 to k are not moved in the real environment, each of the users 1 to k is converged as data corresponding to the k selected from the n targets (tID=1 to n).

For example, the user certainty factor information (uID) included in the data of the target 1 (tID=1) on the top stage among the target information 380 illustrated in FIG. 7 has the highest probability regarding the user 2 (uID₁₂=0.7). Therefore, this data on the target 1 (tID=1) is estimated to correspond to the user 2. It should be noted that (12) in (uID₁₂) among the data [uID₁₂=0.7] indicating the user certainty factor information (uID) indicates that the probability corresponding to the user certainty factor information (uID) of the user=2 of the target ID=1.

The data of the target 1 (tID=1) on the top stage among the target information 380 estimates that the probability that the user is the user 2 is the highest, and the position of the user 2 is within a range indicated by the existing probability distribution data included in the data of the target 1 (tID=1) on the top stage among the target information 380.

In this manner, the target information 380 indicates the following information regarding the respective targets (tID=1 to n) initially set as the virtual objects (virtual users).

(a) The existing position

(b) Who the user is (which one of uID1 to uIDk)

(c) The face attribute expectation value (according to the present processing example, the expectation value (probability) that the user is the speaker)

Therefore, each of k pieces of the target information of the respective targets (tID=1 to n) is converged so as to correspond to the users 1 to k in a case where the users are not moved.

As described above, the audio/image integration processing unit 131 performs the particle update processing based on the input information and generates the following information to be output to the processing decision unit 132.

(a) [The target information] as the estimation information that each of the plurality of users is located where and the user is who

(b) [The signal information] indicating the event generation source such as for example the user who has a discourse

In this manner, the audio/image integration processing unit 131 executes the particle filtering processing to which the plural pieces of target data corresponding to the virtual users are applied and generates analysis information including the position information on the users existing in the real space. That is, each of the target data set in the particle is associated with the respective events input from the event detection unit. Then, in accordance with the input event identifier, the update on the event corresponding target data selected from the respective particles is performed.

In addition, the audio/image integration processing unit 131 calculates a likelihood between the event generation source hypothesis targets set in the respective particles and the event information input from the event detection unit, and set a value in accordance with the magnitude of the likelihood in the respective particles as the particle weight. Then, the audio/image integration processing unit 131 executes a resampling processing of reselecting the particle with the large particle weight in priority and performs the particle update processing. This processing will be described below. Furthermore, regarding the targets set in the respective particles, the update processing while taking the elapsed time into account is executed. Also, in accordance with the number of the event generation source hypothesis targets set in the respective particles, the signal information is generated as the probability value of the event generation source.

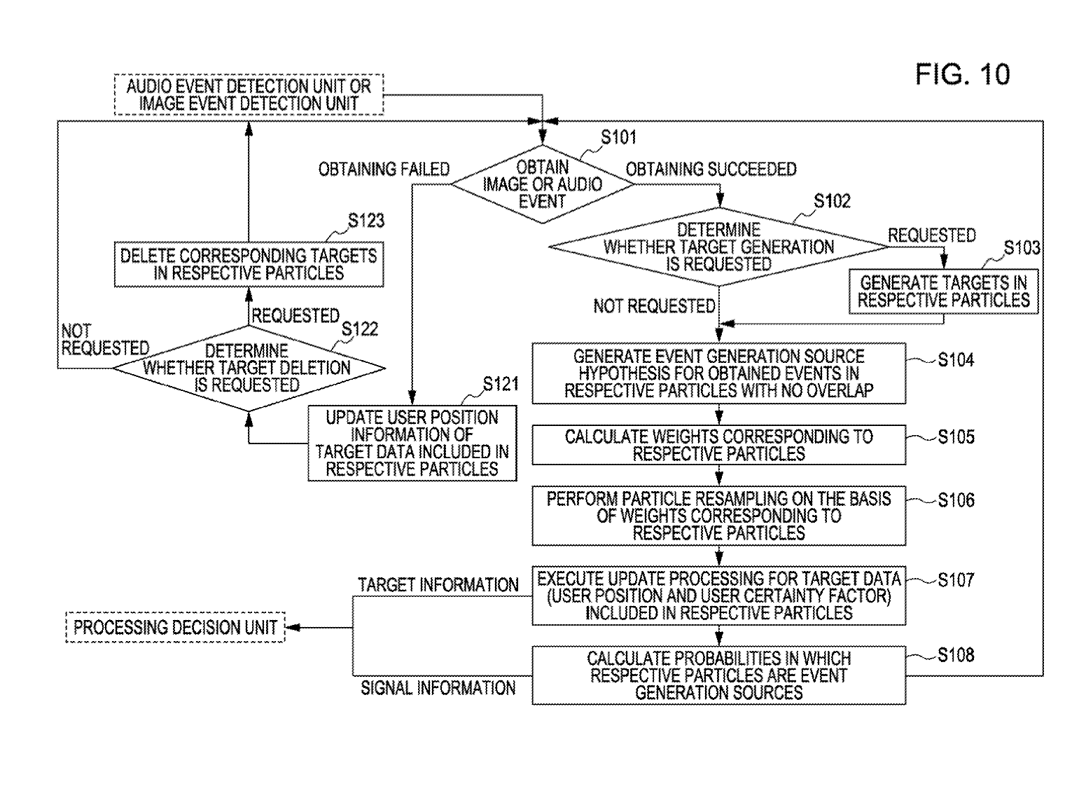

Such a processing sequence will be described with reference to a flowchart shown in FIG. 10. That is, the audio/image integration processing unit 131 inputs the following event information illustrated in FIG. 3B from the audio event detection unit 122 and the image event detection unit 112, that is, the user position information and the user identification information (the face identification information or the speaker identification information).

(a) [The target information] as the estimation information that each of the plurality of users is located where and the user is who

(b) [The signal information] indicating the event generation source such as for example the user who has a discourse

First, in step S101, the audio/image integration processing unit 131 inputs the following pieces of event information from the audio event detection unit 122 and the image event detection unit 112.

(a) The user position information

(b) The user identification information (the face identification information or the speaker identification information)

(c) The face attribute information (the face attribute score)

In a case where obtaining of the event information is succeeded, the flow is advanced to step S102. In a case where obtaining of the event information is failed, the flow is advanced to step S121. The processing in step S121 will be described below.

In a case where obtaining of the event information is succeeded, the audio/image integration processing unit 131 performs the particle update processing based on the input information in step S102 and subsequent steps. Before the particle update processing, first, in step S102, it is determined as to whether or not the new target setting is demanded with respect to the respective particles. In the configuration according to the embodiment of the present invention, as described above with reference to FIG. 5, each of the target 1 to n included in the respective particle 1 to m set by the audio/image integration processing unit 131 is previously associated with the respective pieces of input event information (eID=1 to k). While following the association, the update is configured to be executed on the selected target corresponding to the input event.

Therefore, for example, in a case where the number of events input from the image event detection unit 112 is larger than the number of targets, the new target setting is demanded. To be more specific, for example, the case corresponds to a case where a face which has not existed so far appears in the image frame 350 illustrated in FIG. 5 or the like. In such a case, the flow is advanced to step S103, and the new target is set in the respective particles. This target is set as a target updated while corresponding to this new event.

Next, in step S104, the hypothesis of the event generation source is set for the m particles (pad=1 to m) of the respective particle 1 to m set by the audio/image integration processing unit 131. In the case of the audio event, for example, the event generation source is the user who has a discourse. In the case of the audio event, the event generation source is the user who has the extracted face.

As described above with reference to FIG. 5 and the like, the hypothesis setting processing according to the embodiment of the present invention sets the respective pieces of input event information (eID=1 to k) so as to be associated with each of the target 1 to n included in the particle 1 to m.

That is, as described above with reference to FIG. 5 and the like, it is previously set that the respective targets 1 to n included in the particles 1 to m are associated with the events (eID=1 to k), and which target included in the respective particles is updated. In this manner, the same number of event generation source hypotheses as the obtained events are generated so as to avoid the overlap in the respective particles. It should be noted that in an initial stage, for example, such a setting may be adopted that the respective events are evenly distributed. The number of particles: m is set larger than the number of targets: n, and thus a plurality of particles are set as the particle having such an association of the same event ID and target ID. For example, in a case where the number of targets: n is 10, such a processing of setting the number of particles: m=about 100 to 1000 or the like is performed.

After the hypothesis setting in step S104, the flow is advanced to in step S105. In step S105, the weight corresponding to the respective particles, that is, the particle weight [W_{pID}] is calculated. The particle weight [W_{pID}] is set as a value uniform to the respective particles in an initial stage, but updated in accordance with the event inputs.

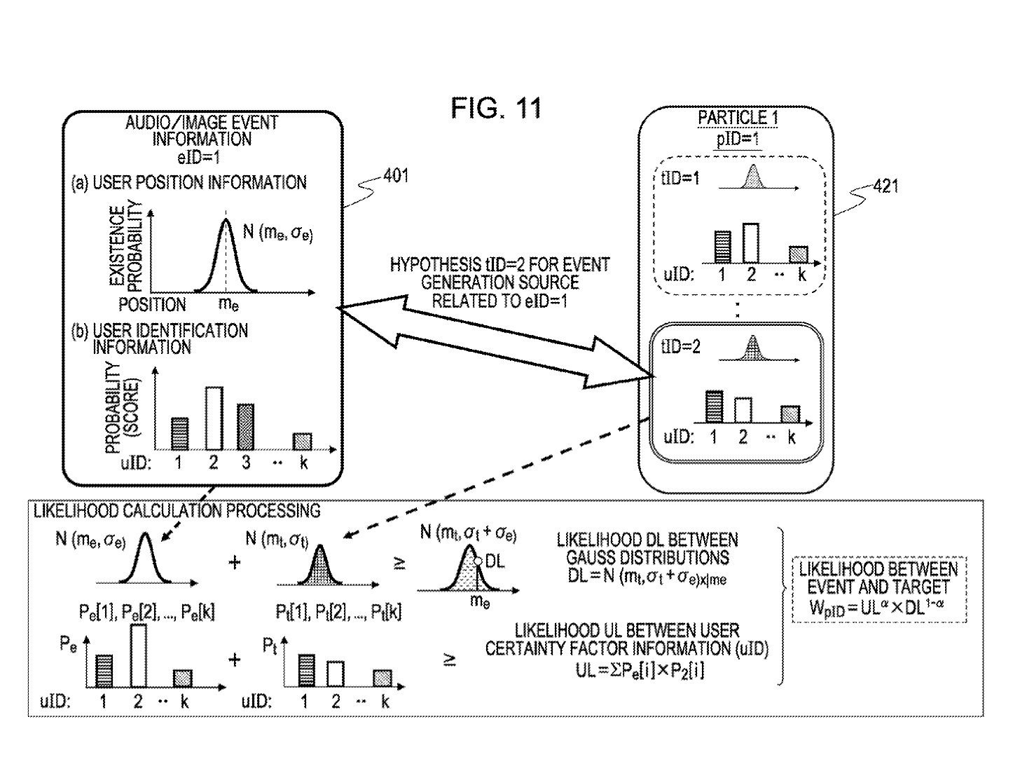

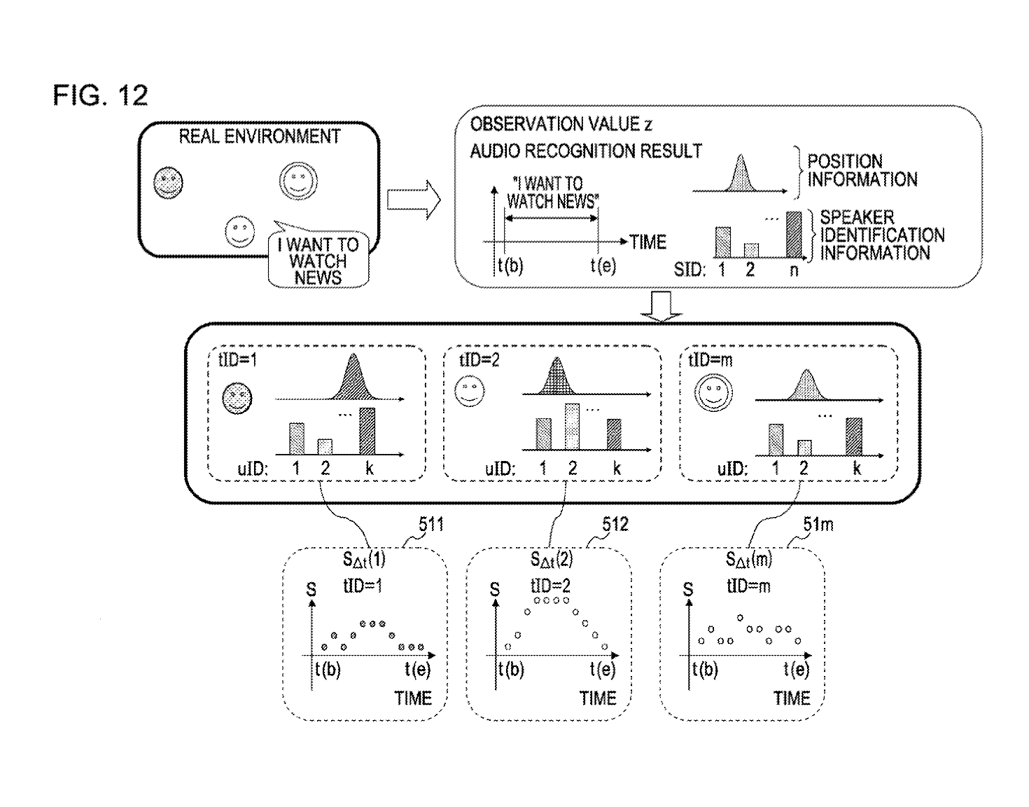

With reference to FIGS. 11 and 12, a detail of the calculation processing for the particle weight [W_{pID}] will be described. The particle weight [W_{pID}] is equivalent to an index of correctness of a hypothesis of the respective particles generating the hypothesis target of the event generation source. The particle weight [W_{pID}] is calculates as a likelihood between the event and the target which is a similarity of the input event of the event generation source corresponding to each of the plurality of targets set in the respective m particles (pad=1 to m).

FIG. 11 illustrates event information 401 corresponding to one event (eID=1) input from the audio event detection unit 122 and the image event detection unit 112 by the audio/image integration processing unit 131 and one particle 421 held by the audio/image integration processing unit 131. The target (tID=2) of the particle 421 is a target associated with the event (eID=1).

On a lower stage of FIG. 11, a calculation processing example for the likelihood between the event and the target is illustrated. The particle weight [W_{pID}] is calculated as a value corresponding to the total sum of the likelihoods between the event and the target calculated in the respective particles as the similarity index of the event-target.

The likelihood calculation processing calculation processing illustrated on the lower stage of FIG. 11 shows an example of individually calculating the following data.

(a) The likelihood [DL] between the Gauss distributions functioning as the similarity data between the event and the target data regarding the user position information

(b) The likelihood [UL] between the user certainty factor information (uID) functioning as the similarity data between the event and the target data regarding the user identification information (the face identification information or the speaker identification information)

(a) The calculation processing for the likelihood [DL] between the Gauss distributions functioning as the similarity data between the event and the hypothesis target regarding the user position information is performed as follows.

The Gauss distribution corresponding to the user position information among the input event information is set as N(mₑ, σₑ).

The Gauss distribution corresponding to the user position information of the hypothesis target selected from the particle is set as N(mₜ, σₜ).

The likelihood [DL] between the Gauss distributions is calculated through the following expression.

DL=N (mₜ, σₜ+σₑ)×|mₑ

The above-mentioned expression is an expression of calculating the value of the position x=mₑ in the Gauss distribution in which the center is mₜ and the variance is σₜ+σₑ.

The calculation processing for the likelihood [UL] between the user certainty factor information (uID) functioning as the similarity data of the event and the hypothesis target regarding (b) the user identification information (the face identification information or the speaker identification information) is as follows.

The value (score) of the confidence factor of the respective users 1 to k regarding the user certainty factor information (uID) among the input event information is set as Pe[i]. It should be noted that i is a variant corresponding to the user identifiers 1 to k.

While the value (score) of the confidence factor of the respective users 1 to k regarding the user certainty factor information (uID) of the hypothesis target selected from the particle is set as Pt[i], the likelihood [UL] between the user certainty factor information (uID) is calculated through the following expression.

UL=ΣPₑ[i]×Pₜ[i]

The above-mentioned expression is an expression for obtaining a total sum of products of values (scores) of the confidence factor corresponding to the respective corresponding users included in the user certainty factor information (uID) of the two pieces of data, and this value is set as the likelihood [UL] between the user certainty factor information (uID).

The particle weight [W_{pID}] is calculated by utilizing the above-mentioned two likelihoods, that is, the likelihood [DL] between the Gauss distributions and the likelihood [UL] between the user certainty factor information (uID) through the following expression with use of a weight α (α=0 to 1).

The particle weight [W_{pID}]=ΣₙUL^{α}×DL^{1-α}

In the expression, n denotes the number of the event corresponding targets included in the particle.

Through the above-mentioned expression, the particle weight [W_{pID}] is calculated.

It should be noted that α=0 to 1.

The particle weight [W_{pID}] is individually calculated for the respective particles.

It should be noted that the weight [α] applied to the calculation for the particle weight [W_{pID}] may be a previously fixed value or such a setting may be adopted that the value is changed in accordance with the input event. For example, when the input event is an image, in a case where the face detection is succeeded and the position information is obtained but the face identification is failed or the like, such a configuration may be adopted that with the setting of α=0, the particle weight [W_{pID}] is calculated only depending on the likelihood [DL] between the Gauss distributions as the likelihood between the user certainty factor information (uID): UL=1. Also, when the input event is an audio, in a case where the speaker identification is succeeded and the speaker information is obtained but obtaining of the position information failed or the like, such a configuration may be adopted that with the setting of α=0, the particle weight [W_{pID}] is calculated only depending on the likelihood [UL] between the user certainty factor information (uID) as the likelihood [DL] between the Gauss distributions=1.

The calculation for the weight [W_{pID}] corresponding to the respective particles in step S105 in the flow of FIG. 10 is executed in the manner as the processing described above with reference to FIG. 11. Next, in step S106, the particle resampling processing based on the particle weight [W_{pID}] of the respective particles set in step S105 is executed.

This particle resampling processing is executed as a processing of sorting out the particles from the m particles in accordance with the particle weight [W_{pID}]. To be more specific, for example, when the number of the particles: m=5, in the case where the following particle weights are respectively set, the particle 1 is resampled at the probability of 40%, and the particle 2 is resampled at the probability of 10%.
The particle 1: the particle weight [W_{pID}]=0.40
The particle 2: the particle weight [W_{pID}]=0.10
The particle 3: the particle weight [W_{pID}]=0.25
The particle 4: the particle weight [W_{pID}]=0.05
The particle 5: the particle weight [W_{pID}]=0.20

It should be noted that in actuality, a large number of m=100 to 1000 is set, and the result after the resampling is composed of the particles at a distribution ratio in accordance with the weight of the particle.

Through this processing, more particles having the large particle weight [W_{pID}] remain. It should be noted that the total number of the particles [m] is not changed even after the resampling. Also, after the resampling, the weight [W_{pID}] of the respective particles is reset, and the processing is repeatedly performed from step S101 in accordance with the input of a new event.

In step S107, the update processing on the target data included in the respective particles (the user position and the user confidence factor) is executed. The respective targets are composed of the following pieces of data as described above with reference to FIG. 7 and the like.

(a) The user position: the probability distribution of the existing positions corresponding to the respective targets [the Gauss distribution: N(mₜ, σₜ)]

(b) The user confidence factor: the probability value (score): Pt[i] (i=1 to k) of the respective users 1 to k as user certainty factor information (uID) indicating who the respective targets are, that is, uIDₜ₁=Pt[1], uIDₜ₂=Pt[2], . . . uIDₜₖ=Pt[k]

(c) The face attribute expectation value (according to the present processing example, the expectation value (probability) that the user is the speaker)

(c) The face attribute expectation value (according to the present processing example, the expectation value (probability) that the user is the speaker) is calculated, as described above, on the basis of the probability equivalent to [the signal information] indicating the event generation source, P_{eID=x}(tID=y), and the face attribute score S_{eID=i} corresponding to the respective events. Denoted by i is an event ID.

For example, the face attribute expectation value of the target ID=1: S_{tID=1} is calculated by the following expression.

S_{tID=1}=Σ_{eID}P_{eID=i}(tID=1)×S_{eID=i}

To be generalized, the face attribute expectation value of the target: S_{tID} is calculated by the following expression.

S_{tID}=Σ_{eID}P_{eID=i}(tID)×S_{eID} (Expression 1)

It should be noted that when the number of targets is larger than the number of face image events, in order that the total sum of the face attribute expectation value [S_{tID}] of the respective targets becomes [1], by using the complement number [1−Σ_{eID}P_{eID}(tID)] and the prior knowledge value [Sₚᵣᵢₒᵣ], the expectation value of the face event attribute[S_{tID}] is calculated through the following expression (Expression 2).

S_{tID}=Σ_{eID}P_{eID}(tID)×S_{eID}+(1−Σ_{eID}P_{eID}(tID))×Sₚᵣᵢₒᵣ (Expression 2)

The update on the target data in step S107 is executed regarding (a) the user position, (b) the user confidence factor, and (c) the face attribute expectation value (according to the present processing example, the expectation value (probability) that the user is the speaker). First, the update processing on (a) the user position will be described.

The user position update is executed as the following two-stage update processings.

(a1) The update processing for subjecting all the targets in all the particles

(a2) The update processing for the event generation source hypothesis target set in the respective particles

(a1) The update processing for subjecting all the targets in all the particles is executed on the targets selected as the event generation source hypothesis target and all other targets. This processing is executed on the basis of a hypothesis that the variance in the user position is expanded along with the time elapse, and updated on the basis of the time elapse since the previous update processing and the position information of the event by using Kalman Filter.

Hereinafter, a description will be given of the update processing example in a case where the position information is one dimensional. First, a time elapse since the previous update processing time is denoted by [dt], and the predicted distribution of the user position after [dt] for all the targets is calculated. That is, regarding the expectation value (average): [mₜ] and the variance [σₜ] of the Gauss distribution: N(mₜ, σₜ) as the user position distribution information, the following update is performed.

mₜ=mₜ+xc×dt

σₜ²=σₜ²+σc²×dt

It should be noted that the reference symbols are as follows.
mₜ: Predicted state
σₜ²: Predicted estimate covariance
xc: Control model
σc²: Process noise

It should be noted that in a case where the processing is performed under a condition that the user is not moved, it is possible to perform the update processing with the setting of xc=0.

Through the above-mentioned calculation processing, the Gauss distribution of the user position information included in all the targets: N(mₜ, σₜ) is updated.

(a2) The update processing for the event generation source hypothesis target set in the respective particles

Next, a description will be given of the update processing for the event generation source hypothesis target set in the respective particles.

The target selected while following the hypothesis of the event generation source set in step S103 is updated. As described above with reference to FIG. 5 and the like, the respective targets 1 to n included in the particles 1 to m are set as targets associated with the respective events (eID=1 to k).

That is, in accordance with the event ID (eID), which target included in the respective particles is updated is previously set. While following the setting, only the target associated with the respective input event is updated. For example, on the basis of the event corresponding information 361 of [Event ID=1 (eID=1)] shown in FIG. 5, in the particle 1 (pad=1), only the data of the target ID=1 (tID=1) is selectively updated.

In the update processing while following this hypothesis of the event generation source, the update of the target associated with the event is updated in this manner. The update processing using the Gauss distribution: N(mₑ, σₑ), for example, which indicates the user position included in the event information input from the audio event detection unit 122 and the image event detection unit 112 is executed.

For example, the reference symbols are as follows.

K: Kalman Gain

mₑ: The observation value (Observed state) included in input event information: N(mₑ, σₑ)

σₑ²: The observation value (Observed covariance) included in input event information: N(mₑ, σₑ)

The following update processing is performed.

K=σₜ²/(σₜ²+σₑ²)

mₜ=mₜ+K(xc−mₜ)

σₜ²=(1−K)σₜ²

Next, the update processing on (b) the user confidence factor executed as the update processing on the target data will be described. The target data includes, in addition to the user position information, the probability (score) of being the respective users 1 to k: Pt[i] (i=1 to k) as user certainty factor information (uID) indicating who the respective targets are. In step S107, the update processing is performed also on this user certainty factor information (uID).

The update on the user certainty factor information (uID): Pt[i] (i=1 to k) of the targets included in the respective particles is performed by applying an update rate [β] having a previously set value in a range of 0 to 1 on the basis of the posterior probabilities for all the registered users and the user certainty factor information (uID): Pe[i] (i=1 to k) included in the event information input from the audio event detection unit 122 and the image event detection unit 112.

The update on the user certainty factor information (uID) of the target: Pt[i] (i=1 to k) is executed through the following expression.

Pt[i]=(1−β)×Pt[i]+β*Pe[i]

It should be noted that the following conditions are established.

i=1 to k

β: 0 to 1

It should be noted that the update rate [β] is a value in a range of 0 to 1 and previously set.

In step S107, the following data included in the updated target data is composed of the following data.

(a) The user position: the probability distribution [the Gauss distribution: N(mₜ, σₜ)] of the existing position corresponding to the respective targets

(b) The probability value (score): Pt[i] (i=1 to k) of the respective users 1 to k as the user confidence factor: user certainty factor information (uID) indicating who the respective targets are, that is, uIDₜ₁=Pt[1], uIDₜ₂=Pt[2], . . . , uIDₜₖ=Pt[k]

(c) The face attribute expectation value (according to the present processing example, the expectation value (probability) that the user is the speaker)

On the basis of the above-mentioned pieces of data and the respective particle weights [W_{pID}], the target information is generated and output to the processing decision unit 132.

It should be noted that the target information is generated as the weighting total sum data of corresponding data to the respective targets (tID=1 to n) included in the respective particles (PID=1 to m). The data is illustrated in the target information 380 at the right end of FIG. 7. The target information is generated as information including the following information of the respective targets (tID=1 to n)

(a) The user position information

(b) The user certainty factor information

(c) The face attribute expectation value (according to the present processing example, the expectation value (probability) that the user is the speaker)

For example, the user position information among the target information corresponding to the target (tID=1) is represented by the following expression.

$${\sum }_{i = 1}^{m} {W}_{i} \cdot N ( {m}_{i 1} , {σ}_{i 1} ) \qquad [ Expression 1 ]$$

Denoted by Wᵢ is the particle weight [W_{pID}].

In addition, the user certainty factor information among the target information corresponding to the target (tID=1) is represented by the following expression.

$${\sum }_{i = 1}^{m} {W}_{i} \cdot {uID}_{i 11} \\ {\sum }_{i = 1}^{m} {W}_{i} \cdot {uID}_{i 12} \\ ⋮ \\ {\sum }_{i = 1}^{m} \cdot {W}_{i} \cdot {uID}_{i 1 k} \qquad [ Expression 2 ]$$

In the above expression, Wᵢ denotes the particle weight [W_{pID}].

In addition, the face attribute expectation value (according to the present processing example, the expectation value (probability) that the user is the speaker) among the target information corresponding to the target (tID=1) is represented by one of the following expressions.

S_{tID=1}=Σ_{eID}P_{eID=i}(tID=1)×S_{eID=i}

S_{tID=1}=Σ_{eID}P_{eID=i}(tID=1)×S_{eID=i}+(1−σ_{eID}P_{eID}(tID=1)×Sₚᵣᵢₒᵣ

The audio/image integration processing unit 131 calculates the above-mentioned target information for the respective n targets (tID=1 to n), and outputs the calculated target information to the processing decision unit 132.

Next, a description will be given of the processing in step S108 in the flow of FIG. 8. In step S108, the audio/image integration processing unit 131 calculates the probability that each of the n targets (tID=1 to n) is the event generation source, and outputs this information as the signal information to the processing decision unit 132.

As described above, regarding the audio event, [the signal information] indicating the event generation source is data on who has a discourse, that is, data indicating [the speaker]. Regarding the image event, [the signal information] is data indicating the face included in the image is whose and [the speaker].

On the basis of the number of hypothesis targets of the event generation source set in the respective particles, the audio/image integration processing unit 131 calculates the probability that each of the respective targets is the event generation source. That is, the probability that each of the targets (tID=1 to n) is the event generation source is denoted by [P(tID=i), where i=1 to n. For example, as described above, the probability that the generation source of a certain event (eID=y) is a particular target x (tID=x) is represented as follows.

P_{eID=x}(tID=y)

This is equivalent to the ratio of the number of particles (m) set by the audio/image integration processing unit 131 to the number of targets assigned to the respective events. For example, in the example shown in FIG. 5, the following corresponding relation is established.

The number of particles in which P_{eID=1}(tID=1)=[the first event (eID=1) is allocated with tID=1)/(m)]

The number of particles in which P_{eID=1}(tID=2)=[the first event (eID=1) is allocated with tID=2)/(m)]

The number of particles in which P_{eID=2}(tID=1)=[the second event (eID=2) is allocated with tID=1)/(m)]

The number of particles in which P_{eID=2}(tID=2)=[the second event (eID=2) is allocated with tID=2)/(m)]

This data is output as [the signal information] indicating the event generation source to the processing decision unit 132.

When the processing in step S108 is ended, the flow is returned to step S101, and the state is shifted to a standby state for the input of event information from the audio event detection unit 122 and the image event detection unit 112.

The above description is for steps S101 to S108 in the flow illustrated in FIG. 10. In step S101, even in a case where the audio/image integration processing unit 131 does not obtain the event information illustrated in FIG. 3B from the audio event detection unit 122 and the image event detection unit 112, in step S121, the update of the target configuration data included in the respective particles is executed. This update is a processing taking into account a change in the user position along with the time elapse.

This target update processing is similar to (a1) the update processing for subjecting all the targets in all the particles described-above in step S107. The target update processing is executed on the basis of the hypothesis that the variance in the user position along with the time elapse is expanded. The update is performed on the basis of the time elapse since the previous update processing and the position information of the event by using Kalman Filter.

A description will be given of the update processing example in a case where the position information is one dimensional. First, a time elapse since the previous update processing time is denoted by [dt], and a predicted distribution of the user position after [dt] for all the targets is calculated. That is, regarding the expectation value (average): [mₜ] and the variance [σₜ] of the Gauss distribution: N(mₜ, σₜ) as the user position distribution information, the following update is performed.

mₜ=mₜ+xc×dt

σₜ²=σₜ²+σc²×dt

It should be noted that the reference symbols are as follows.
mₜ: Predicted state)
σₜ²: Predicted estimate covariance)
xc: Control model)
σc²: Process noise)

It should be noted that in a case where the processing is performed under a condition that the user is not moved, it is possible to perform the update processing with the setting of xc=0.

Through the above-mentioned calculation processing, the update is performed on the Gauss distribution: N(mₜ, σₜ) as the user position information included in all the targets.

It should be noted that the user certainty factor information (uID) included in the target of the respective particles is not updated unless the posterior probability for all the event registered users is not obtained or the score [Pe] from the event information is obtained.

When the processing in step S121 is ended, in step S122, it is determined as to whether the target is to be deleted. When it is determined that the target is to be deleted, in step S123, the target is deleted. The target deletion is executed as a processing of deleting data in which a particular user position is not obtained, for example, in a case where the peak is not detected in the user position information included in the target or the like. In the case where such a target does not exist, after the processing in steps S122 and S123 where the deletion processing is not performed, the flow is returned to step S101. The state is shifted to the standby state for the input of the event information from the audio event detection unit 122 and the image event detection unit 112.

The processing executed by the audio/image integration processing unit 131 has been described in the above with reference to FIG. 10. The audio/image integration processing unit 131 repeatedly executes the processing while following the flow illustrated FIG. 10 each time when the event information is input from the audio event detection unit 122 and the image event detection unit 112. Through this repeated processing, the weight of the particle in which the targets with a higher reliability are set as the hypothesis targets is increased, and through the resampling processing based on the particle weight, the particle with the larger weight is remained. As a result, the data with a higher reliability which is similar to the event information input from the audio event detection unit 122 and the image event detection unit 112 is remained. Eventually, the following information with the high reliability are generated and output to the processing decision unit 132.

(a) [The target information] as the estimation information that each of the plurality of users is located where and the user is who

(b) [The signal information] indicating the event generation source such as for example the user who has a discourse

### [Speaker Identification Processing (Diarization)]

According to the above-mentioned embodiment, in the audio/image integration processing unit 131, the face attribute score [S(tID)] of the event corresponding target of the respective particles is sequentially updated for each of the image frames processed by the image event detection unit 112. It should be noted that a value of the face attribute value [S(tID)] is updated while being normalized as occasion demands. The face attribute score[S(tID)] is a score in accordance with the mouth motion according to the present processing example, and also is a score calculated by applying VSD (Visual Speech Detection.

In this processing procedure, for example, during a certain time period, Δt=t_end to t_begin, the audio event is input, and the audio source direction information of the audio event and the speaker identification information are assumed to be obtained. A speech source probability of the target tID only obtained from the audio source direction information of the audio event, the user position information obtained from the speaker identification information, and the user identification information is set as P(tID).

The audio/image integration processing unit 131 can calculate the speaker probability of the respective targets by integrating this speech source probability [P(tID)] and the face attribute value [S(tID)] of the event corresponding target of the respective particles through the following method. Through this method, it is possible to improve the performance of the speaker identification processing.

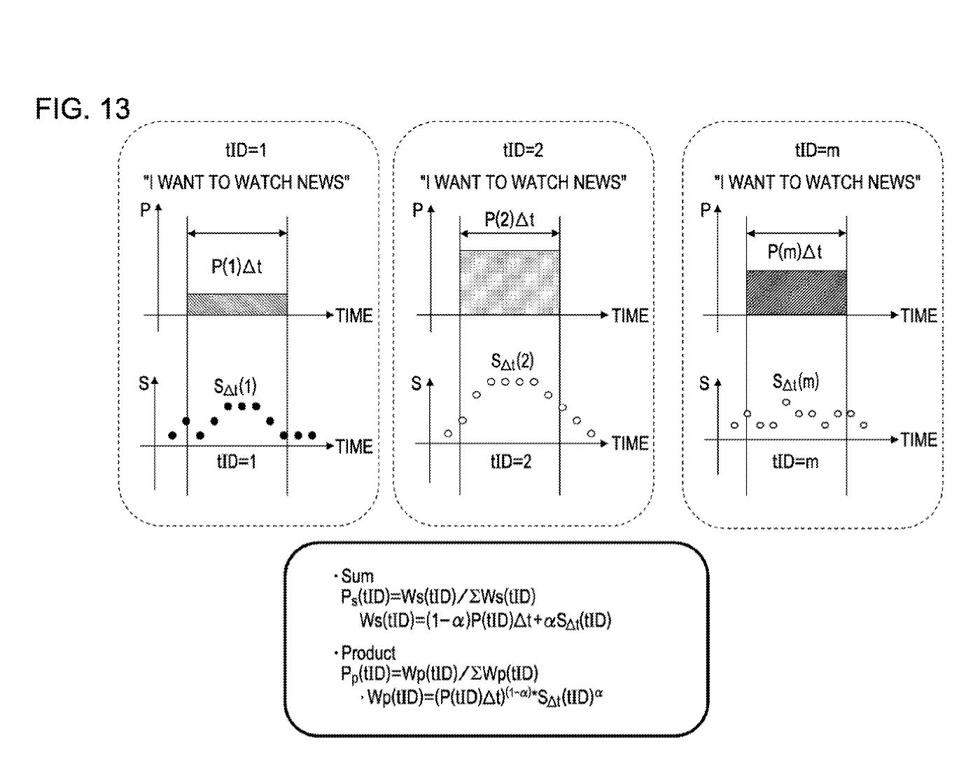

This processing will be described in with reference to FIGS. 12 and 13.

The face attribute score [S(tID)] the target tID at the time t is set as S(tID)t. As illustrated in [observation value z] in the upper right stage of FIG. 12, an interval of the audio events is set as [t_begin, to t_end]. Time series data in which the score values of the face attribute score [S(tID)] of the m event corresponding target (tID=1, 2, . . . m) illustrated in the middle stage of FIG. 12 are arranged in the input period of the audio event [t_begin, to t_end] is set as face attribute score time series data 511, 512, . . . 51m illustrated in the low stage of FIG. 12. The area of the face attribute score [S(tID)] of the time series data is set as S_{Δt}(tID).

In order to integrate the following two values, such a processing is performed.

(a) The speech source probability P(tID) of the target tID obtained only from the audio source direction information of the audio event, the user position information obtained from the speaker identification information, and the user identification information

(b) The area S_{Δt}(tID) of the face attribute score [S(tID)]

First, P(tID) is multiplied by Δt and the following calculation is performed

P(tID)×Δt

Then, S_{Δt}(tID) is normalized through the following expression.

S_{Δt}(tID)<=S_{Δt}(tID)/Σ_{tID}S_{Δt}(tID) (Expression 3)

The upper stage of FIG. 13 illustrates the following respective values calculated in this manner for the respective targets (tID=1, 2, m).

P(tID)×Δt

S_{Δt(tID)}

Furthermore, the speaker probability Ps(tID) or Pp(tID) of the respective targets(tID=1 to m) is calculated through the addition or multiplication while taking the weight into account by using a functioning as distribution weighting factors of the following (a) and (b).

(a) The speech source probability P(tID) of the target tID obtained only from the audio source direction information of the audio event, the user position information obtained from the speaker identification information, and the user identification information

(b) The area S_{Δt}(tID) of the face attribute score[S(tID)]

The speaker probability Ps(tID) of the target calculated through the addition while taking the weight a into account is calculated through the following expression (Expression 4).

Ps(tID)=Ws(tID)/ΣWs(tID) (Expression 4)

It should be noted that Ws(tID)=(1−α)P(tID)Δt+αS_{Δt}(tID)

In addition, the speaker probability Pp(tID) of the target calculated through the multiplication while taking the weight α into account is calculated through the following expression (Expression 5).

Pp(tID)=Wp(tID)/ΣWp(tID) (Expression 5)

It should be noted that Wp(tID)=(P(tID)Δt)^{(1-α)}×S_{Δt}(tID)^{α}

These expressions are illustrated in the lower end of FIG. 13.

By applying one of these expressions, the performance of the probability estimation that the respective targets are the event generation source is improved. That is, as the speech source estimation is performed while integrating the speech source probability [P(tID)] of the target tID obtained only from the audio source direction information of the audio event, the user position information obtained from the speaker identification information, and the user identification information and the face attribute value [S(tID)] of the event corresponding target of the respective particles, it is possible to improve the diarization performance as the speaker identification processing.

In the above, the present invention has been described in detail with reference to the particular embodiments. However, it should be understood by those skilled in the art that various modifications, combinations, sub-combinations and alterations may occur depending on design requirements and other factors insofar as they are within the scope of the appended claims or the equivalents thereof. That is, the present invention has been disclosed by way of the mode of examples, and should not be construed to a limited extent. In order to determine the gist of the present invention, the claims should be taken into account.

In addition, the series of the processings described in the specification can be executed by hardware, software, or a composite configuration of the hardware and the software. In a case where the processings are executed by the software, it is possible that the program recording the processing sequence is installed into a memory in a computer which is accommodated in dedicated use hardware and executed, or the program is installed into a general use computer capable of executing various processings and executed. For example, the program can be recorded on the recording medium in advance. In addition to the installment from the recording medium to the computer, it is also possible that the program is received via a LAN (Local Area Network or a network such as the internet, and installed on the recording medium such as built-in hard disk.

It should be noted that the various processings described in the specification may be not only executed in a time series manner by following the description but also executed in parallel or individually in accordance with a processing performance of an apparatus which executes the processings or as occasion demands. In addition, the system in the present specification is a logical collective configuration of a plurality of apparatuses and is not limited to a case where the apparatuses of the respective configurations are in the same casing.

What is claimed is:

1. An information processing apparatus comprising:
a plurality of information input units configured to input observation information in a real space;
an event detection unit configured to generate event information including estimated position information and estimated identification information on users existing in the actual space through an analysis of the information input from the information input units; and
an information integration processing unit configured to set hypothesis probability distribution data related to position information and identification information on the users and generate analysis information including the position information on the users existing in the real space through a hypothesis update and a sorting out based on the event information,
wherein the event detection unit is a configuration of detecting a face area from an image frame input from an image information input unit, extracting face attribute information from the detected face area, calculating a face attribute score corresponding to the extracted face attribute information, and outputting the face attribute score to the information integration processing unit, and
wherein the information integration processing unit applies the face attribute score input from the event detection unit and calculates face attribute expectation values corresponding to the respective targets.

2. The information processing apparatus according to claim 1,
wherein the information integration processing unit is a configuration of executing a particle filter processing to which a plurality of particles are applied in which plural pieces of target data corresponding to virtual uses are set and generating the analysis information including the position information on the users existing in the real space, and
wherein the information integration processing unit has a configuration of setting the respective pieces of target data set to the particles while being associated with the respective events input from the event detection unit, and updating the event corresponding target data selected from the respective particles in accordance with an input event identifier.

3. The information processing apparatus according to claim 1,
wherein the information integration processing unit has a configuration of performing the processing while associating the targets with the respective events in units of a face image detected in the event detection unit.

4. The information processing apparatus according to claim 1,
wherein the information integration processing unit is a configuration of executing the particle filtering processing and generating the analysis information including the user position information and the user identification information on the users existing in the real space.

5. The information processing apparatus according to claim 1,
wherein the face attribute score detected by the event detection unit is a score generated on the basis of a mouth motion in the face area, and
wherein the face attribute expectation value generated by the information integration processing unit is a value corresponding to a probability that the target is a speaker.

6. The information processing apparatus according to claim 5,
wherein the event detection unit executes the detection of the mouth motion in the face area through a processing to which VSD (Visual Speech Detection) is applied.

7. The information processing apparatus according to claim 1,
wherein the information integration processing unit uses a value of a prior knowledge [Sₚᵣᵢₒᵣ] set in advance in a case where the event information input from the event detection unit does not include the face attribute score.

8. The information processing apparatus according to claim 1,
wherein the information integration processing unit is a configuration of applying a value of the face attribute score and a speech source probability P(tID) of the target calculated from the user position information and the user identification information during an audio input period which are obtained from the detection information of the event detection unit and calculating speaker probabilities of the respective targets.

9. The information processing apparatus according to claim 8,
wherein when the audio input period is set as Δt, the information integration processing unit is a configuration of calculating speaker probabilities [Ps(tID)] of the respective targets through a weighting addition to which the speech source probability P[(tID)] and the face attribute score [S(tID)] are applied, by using the following expression:
Ps(tID)=Ws(tID)/ΣWs(tID)
wherein
Ws(tID)=(1−α)P(tID)Δt+αS_{Δt}(tID)
α is a weighting factor.

10. The information processing apparatus according to claim 8,
wherein when the audio input period is set as Δt, the information integration processing unit is a configuration of calculating speaker probabilities [Pp(tID)] of the respective targets through a weighting multiplication to which the speech source probability P[(tID)] and the face attribute score [S(tID)] are applied, by using the following expression:
Pp(tID)=Wp(tID)/ΣWp(tID)
wherein
Wp(tID)=(P(tID)Δt)^{(1-α)}×S_{Δt}(tID)^{α}
α is a weighting factor.

11. The information processing apparatus according to claim 1,
wherein the event detection unit is a configuration of generating the event information including estimated position information on the user which is composed of a Gauss distribution and user certainty factor information indicating a probability value of a user correspondence, and
wherein the information integration processing unit is a configuration of holding particles in which a plurality of targets having the user position information composed of a Gauss distribution corresponding to a virtual user and confidence factor information indicating the probability value of the user correspondence are set.

12. The information processing apparatus according to claim 1,
wherein the information integration processing unit is a configuration of calculating a likelihood between event generation source hypothesis targets set in the respective particles and the event information input from the event detection unit and setting values in accordance with the magnitude of the likelihood in the respective particles as particle weights.

13. The information processing apparatus according to claim 2,
wherein the information integration processing unit is a configuration of executing a resampling processing of reselecting the particle with the large particle weight in priority and performing an update processing on the particles.

14. The information processing apparatus according to claim 2,
wherein the information integration processing unit is a configuration of executing an update processing on the targets set in the respective particles in consideration with an elapsed time.

15. The information processing apparatus according to claim 2,
wherein the information integration processing unit is a configuration of generating signal information as a probability value of an event generation source in accordance with the number of event generation source hypothesis targets set in the respective particles.

16. An information processing method of executing an information analysis processing in an information processing apparatus, the information processing method comprising the steps of:
inputting observation information in a real space by a plurality of information input units;
generating event information including estimated position information and estimated identification information on users existing in the actual space by an event detection unit through an analysis of the information input from the information input units; and
setting hypothesis probability distribution data related to position information and identification information on the users and generating analysis information including the position information on the users existing in the real space by an information integration processing unit through a hypothesis update and a sorting out based on the event information,
wherein the event detection step includes detecting a face area from an image frame input from an image information input unit, extracting face attribute information from the detected face area, calculating a face attribute score corresponding to the extracted face attribute information, and outputting the face attribute score to the information integration processing unit, and
wherein the information integration processing step includes applying the face attribute score input from the event detection unit and calculating face attribute expectation values corresponding to the respective targets.

17. The information processing method according to claim 16,
wherein the information integration processing step includes performing the processing while associating the targets with the respective events in units of a face image detected in the event detection unit.

18. The information processing method according to claim 16,
wherein the face attribute score detected by the event detection unit is a score generated on the basis of a mouth motion in the face area, and
wherein the face attribute expectation value generated in the information integration processing step is a value corresponding to a probability that the target is a speaker.

19. A computer program for executing an information analysis processing in an information processing apparatus, the computer program comprising the steps of:
inputting observation information in a real space by a plurality of information input units;
generating event information including estimated position information and estimated identification information on users existing in the actual space by an event detection unit through an analysis of the information input from the information input units; and
setting hypothesis probability distribution data related to position information and identification information on the users and generating analysis information including the position information on the users existing in the real space by an information integration processing unit through a hypothesis update and a sorting out based on the event information,
wherein the event detection step includes detecting a face area from an image frame input from an image information input unit, extracting face attribute information from the detected face area, calculating a face attribute score corresponding to the extracted face attribute information, and outputting the face attribute score to the information integration processing unit, and
wherein the information integration processing step includes applying the face attribute score input from the event detection unit and calculating face attribute expectation values corresponding to the respective targets.

20. An information processing apparatus comprising:
a plurality of information input means for inputting observation information in a real space;
an event detection means for generating event information including estimated position information and estimated identification information on users existing in the actual space through an analysis of the information input from the information input units; and
an information integration processing means for setting hypothesis probability distribution data related to position information and identification information on the users and generate analysis information including the position information on the users existing in the real space through a hypothesis update and a sorting out based on the event information,
wherein the event detection means is a configuration of detecting a face area from an image frame input from image information input means, extracting face attribute information from the detected face area, calculating a face attribute score corresponding to the extracted face attribute information, and outputting the face attribute score to the information integration processing means, and
wherein the information integration processing means applies the face attribute score input from the event detection means and calculates face attribute expectation values corresponding to the respective targets.
